(19) United States
(12) Patent Application Publication
(10) Pub. No.: US 2026/0120333 A1
(43) Pub. Date: Apr. 30, 2026

(54) ENCODING DEVICE, DECODING DEVICE, ENCODING METHOD, AND DECODING METHOD

(71) Applicant: Panasonic Intellectual Property Corporation of America, Torrance, CA (US)

(72) Inventors: Takahiro NISHI, Nara (JP); Toshiyasu SUGIO, Osaka (JP); Noritaka IGUCHI, Osaka (JP); Chong Soon LIM, Singapore (SG); Zheng WU, Singapore (SG); Han Boon TEO, Singapore (SG); Keng Liang LOI, Singapore (SG); Chung Dean HAN, Johor Bahru (MY); Farman DUMANOV, Singapore (SG); Kian Soon CHENG, Johor Bahru (MY); Praveen Kumar YADAV, Singapore (SG)

(21) Appl. No.: 19/432,385

(22) Filed: Dec. 24, 2025

Related U.S. Application Data
(63) Continuation of application No. PCT/JP2024/023931, filed on Jul. 2, 2024.
(60) Provisional application No. 63/525,188, filed on Jul. 6, 2023.

(51) Int. Cl. G06T 9/00; G06T 15/04; G06T 17/20

(52) U.S. Cl. CPC G06T 9/001; G06T 15/04; G06T 17/20

(57) ABSTRACT

An encoding device includes a circuit and memory connected to the circuit. In operation, the circuit: based on positions of a plurality of second vertices generated based on positions of a plurality of first vertices included in a first three-dimensional mesh frame, calculates texture coordinates indicating positions of the plurality of second vertices in a two-dimensional coordinate system; and encodes, into a bitstream, (i) position information indicating the positions of the plurality of first vertices and (ii) a texture image that is in accordance with the texture coordinates.

### CROSS REFERENCE TO RELATED APPLICATIONS

This is a continuation application of PCT International Application No. PCT/JP2024/023931 filed on Jul. 2, 2024, designating the United States of America, which is based on and claims priority of U.S. Provisional Ser. No. 63/525,188 filed on Jul. 6, 2023. The entire disclosures of the above-identified applications, including the specifications, drawings and claims are incorporated herein by reference in their entirety.

### FIELD

The present disclosure relates to, for example, an encoding device.

### BACKGROUND

Patent Literature (PTL) 1 proposes a device and a method for encoding and decoding three-dimensional mesh data.

### CITATION LIST

### Patent Literature PTL 1: Japanese Unexamined Patent Application Publication No. 2006-187015

### SUMMARY

### Technical Problem

There are demands for further improvement in processing of encoding or decoding three-dimensional data. The present disclosure improves processing of encoding or decoding three-dimensional data.

### Solution to Problem

An encoding device according to an aspect of the present disclosure includes: a circuit; and memory connected to the circuit, in which, in operation, the circuit: based on positions of a plurality of second vertices generated based on positions of a plurality of first vertices included in a first three-dimensional mesh frame, calculates texture coordinates indicating positions of the plurality of second vertices in a two-dimensional coordinate system; and encodes, into a bitstream, (i) position information indicating the positions of the plurality of first vertices and (ii) a texture image that is in accordance with the texture coordinates.

Note that these general or specific aspects may be implemented using a system, a device, a method, an integrated circuit, a computer program, or a non-transitory computer-readable recording medium such as a compact disc read only memory (CD-ROM), or any combination of systems, devices, methods, integrated circuits, computer programs, and recording media.

### Advantageous Effects

The present disclosure can contribute toward improving processing of, for example, encoding three-dimensional data.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a conceptual diagram illustrating a three-dimensional mesh according to an embodiment.

FIG. 2 is a conceptual diagram illustrating basic elements of the three-dimensional mesh according to the embodiment.

FIG. 3 is a conceptual diagram illustrating mapping according to the embodiment.

FIG. 4 is a block diagram illustrating a configuration example of an encoding and decoding system according to the embodiment.

FIG. 5 is a block diagram illustrating a configuration example of an encoding device according to the embodiment.

FIG. 6 is a block diagram illustrating another configuration example of the encoding device according to the embodiment.

FIG. 7 is a block diagram illustrating a configuration example of a decoding device according to the embodiment.

FIG. 8 is a block diagram illustrating another configuration example of the decoding device according to the embodiment.

FIG. 9 is a conceptual diagram illustrating a configuration example of a bitstream according to the embodiment.

FIG. 10 is a conceptual diagram illustrating another configuration example of the bitstream according to the embodiment.

FIG. 11 is a conceptual diagram illustrating yet another configuration example of the bitstream according to the embodiment.

FIG. 12 is a block diagram illustrating a specific example of the encoding and decoding system according to the embodiment.

FIG. 13 is a conceptual diagram illustrating a configuration example of point cloud data according to the embodiment.

FIG. 14 is a conceptual diagram illustrating a data file example of the point cloud data according to the embodiment.

FIG. 15 is a conceptual diagram illustrating a configuration example of mesh data according to the embodiment.

FIG. 16 is a conceptual diagram illustrating a data file example of the mesh data according to the embodiment.

FIG. 17 is a conceptual diagram illustrating a type of three-dimensional data according to the embodiment.

FIG. 18 is a block diagram illustrating a configuration example of a three-dimensional data encoder according to the embodiment.

FIG. 19 is a block diagram illustrating a configuration example of a three-dimensional data decoder according to the embodiment.

FIG. 20 is a block diagram illustrating another configuration example of the three-dimensional data encoder according to the embodiment.

FIG. 21 is a block diagram illustrating another configuration example of the three-dimensional data decoder according to the embodiment.

FIG. 22 is a conceptual diagram illustrating a specific example of encoding processing according to the embodiment.

FIG. 23 is a conceptual diagram illustrating a specific example of decoding processing according to the embodiment.

FIG. 24 is a block diagram illustrating an implementation example of the encoding device according to the embodiment.

FIG. 25 is a block diagram illustrating an implementation example of the decoding device according to the embodiment.

FIG. 26 is a block diagram illustrating a configuration example of an encoding and decoding system according to the embodiment.

FIG. 27 is a block diagram illustrating another configuration example of the encoding device according to the embodiment.

FIG. 28 is a block diagram illustrating another configuration example of the decoding device according to the embodiment.

FIG. 29 is a block diagram illustrating yet another configuration example of the encoding device according to the embodiment.

FIG. 30 is a block diagram illustrating yet another configuration example of the decoding device according to the embodiment.

FIG. 31 is a flowchart illustrating a process performed by the encoding device according to the embodiment.

FIG. 32 is an explanatory diagram schematically illustrating encoding of a mesh frame according to the embodiment.

FIG. 33 is a flowchart illustrating a process performed by the decoding device according to the embodiment.

FIG. 34 is an explanatory diagram schematically illustrating decoding of a mesh frame according to the embodiment.

FIG. 35 is a block diagram illustrating yet another configuration example of the encoding device according to the embodiment.

FIG. 36 is a block diagram illustrating yet another configuration example of the decoding device according to the embodiment.

FIG. 37 is a block diagram illustrating a detailed configuration example of the decoding device according to the embodiment.

FIG. 38 is an explanatory diagram illustrating an example of subdivision according to the embodiment.

FIG. 39 is an explanatory diagram illustrating an example of vertex displacement in which vertices are subdivided and then displaced, according to the embodiment.

FIG. 40 is an explanatory diagram illustrating an example of the vertices of an original mesh according to the embodiment.

FIG. 41 is an explanatory diagram illustrating an example of a mesh according to the embodiment.

FIG. 42 is an explanatory diagram illustrating an example of division of a mesh into submeshes according to the embodiment.

FIG. 43 is a first explanatory diagram illustrating an example of packing of displacement information into an image frame according to the embodiment.

FIG. 44 is a second explanatory diagram illustrating an example of packing of displacement information into an image frame according to the embodiment.

FIG. 45 is a third explanatory diagram illustrating an example of packing of displacement information into an image frame according to the embodiment.

FIG. 46 is an explanatory diagram illustrating textures according to the embodiment.

FIG. 47 is an explanatory diagram illustrating textures according to the embodiment.

FIG. 48 is an explanatory diagram illustrating textures according to the embodiment.

FIG. 49 is an explanatory diagram illustrating textures according to the embodiment.

FIG. 50 is an explanatory diagram illustrating textures according to the embodiment.

FIG. 51 is an explanatory diagram illustrating textures according to the embodiment.

FIG. 52 is a block diagram illustrating yet another configuration example of the encoding device according to the embodiment.

FIG. 53 is a block diagram illustrating yet another configuration example of the decoding device according to the embodiment.

FIG. 54 is a block diagram illustrating yet another configuration example of the encoding device according to the embodiment.

FIG. 55 is a block diagram illustrating yet another configuration example of the decoding device according to the embodiment.

FIG. 56 is a flowchart illustrating an example of a texture coordinate derivation process according to the embodiment.

FIG. 57 is a flowchart illustrating another example of a texture coordinate derivation process according to the embodiment.

FIG. 58 is a diagram illustrating an example of a layout of syntax parameters according to the embodiment.

FIG. 59 illustrates an example of a syntax for signaling a first parameter according to the embodiment.

FIG. 60 illustrates an example of a syntax for signaling a second parameter according to the embodiment.

FIG. 61 is a flowchart illustrating an example of a basic encoding process according to the embodiment.

FIG. 62 is a flowchart illustrating an example of a basic decoding process according to the embodiment.

### DESCRIPTION OF EMBODIMENTS

### Outline of the Present Disclosure

The present disclosure relates to an encoding device, a decoding device, an encoding method, and a decoding method for texture parametrization of a three-dimensional (3D) mesh frame. Specifically, the present disclosure relates to multimedia data coding, and particularly to systems, constituent elements, and methods in multimedia data encoding and decoding. The multimedia data includes three-dimensional digital representation of any object or surface in computer graphics applications. Particularly, a static three-dimensional model and a moving (animated) three-dimensional model that are represented with meshes including triangular meshes are included. Video can also be included in the multimedia data.

With advancement in video coding technology, from H.261 and MPEG-1 to H.264/AVC (Advanced Video Coding), MPEG-LA, H.265/HEVC (High Efficiency Video Coding) and H.266/VVC (Versatile Video Codec), there remains a constant need to provide improvements and optimizations to the video coding technology to process an ever-increasing amount of digital video data in various applications. The present disclosure relates to further advancements, improvements, and optimizations in video coding.

The encoding process for position information of three-dimensional points (vertices (also referred to as vertexes)) described in each of one or more embodiments of the present disclosure can be applied to encoding of position information of three-dimensional points in point cloud compression methods such as video-based point cloud compression (V-PCC) or geometry-based point cloud compression (G-PCC).

There are demands for further improvement in processing of encoding or decoding three-dimensional data. The present disclosure improves processing of encoding or decoding three-dimensional data.

Hereinafter, aspects of the invention derived from the content of the disclosure of the present specification will be described by way of example, and advantageous effects and the like obtained from the aspects of the invention will be described.

An encoding device according to Example 1 includes a circuit and memory connected to the circuit, in which, in operation, the circuit: based on positions of a plurality of second vertices generated based on positions of a plurality of first vertices included in a first three-dimensional mesh frame, calculates texture coordinates indicating positions of the plurality of second vertices in a two-dimensional coordinate system; and encodes, into a bitstream, (i) position information indicating the positions of the plurality of first vertices and (ii) a texture image that is in accordance with the texture coordinates.

The plurality of second vertices are generated as a result of subdivision of the first three-dimensional mesh frame, for example. This makes it possible to generate a mesh frame denser than the first three-dimensional mesh frame. By calculating texture coordinates based on the mesh frame generated in such a manner, that is, by determining the texture of the mesh frame, it is possible to determine the texture coordinates more finely than in the case of calculating the texture coordinates based on the plurality of first vertices. Accordingly, defects such as application of a wrong texture or no texture to the first three-dimensional mesh frame by a decoding process or the like can be inhibited.

An encoding device according to Example 2 is the encoding device according to Example 1, in which the circuit may further generate the texture image based on the texture coordinates.

With this, only the texture image related to the calculated texture coordinates is encoded into the bitstream. Accordingly, the code amount of the bitstream is reduced.

An encoding device according to Example 3 is the encoding device according to Example 1 or 2, in which the circuit may further generate the plurality of second vertices by subdividing the first three-dimensional mesh frame.

This makes it possible to determine the texture coordinates more finely than in the case of calculating the texture coordinates based on the plurality of first vertices.

An encoding device according to Example 4 is the encoding device according to any one of Examples 1 to 3, in which the circuit may further encode, into the bitstream, first count information indicating a total number of times the first three-dimensional mesh frame is subdivided to calculate the texture coordinates.

This makes it possible to perform subdivisions the same number of times in encoding and decoding. Accordingly, the quality of the three-dimensional mesh frame reconstructed by a decoding device can be improved.

An encoding device according to Example 5 is the encoding device according to any one of Examples 1 to 4, in which the circuit may further encode, into the bitstream, second count information indicating a total number of times the first three-dimensional mesh frame is subdivided to generate a second three-dimensional mesh frame from the first three-dimensional mesh frame.

With this, for example, even when a difference exists between the total number of times the first three-dimensional mesh frame is subdivided to calculate texture coordinates and the total number of times the first three-dimensional mesh frame is subdivided to generate the second three-dimensional mesh frame from the first three-dimensional mesh frame, the encoding device and the decoding device can perform subdivisions the same number of times. Accordingly, the quality of the three-dimensional mesh frame reconstructed by the decoding device can be improved.

An encoding device according to Example 6 is the encoding device according to any one of Examples 1 to 5, in which the circuit may further: displace the plurality of second vertices; and when calculating the texture coordinates, calculate the texture coordinates based on the positions of the plurality of second vertices after displacement.

With this, even when vertices are displaced and then position information indicating the positions of the displaced vertices is encoded, the encoding device and the decoding device can calculate texture coordinates using vertices of the same positions.

An encoding device according to Example 7 is the encoding device according to any one of Examples 1 to 6, in which the circuit may encode, into the bitstream, flag information indicating whether to displace the plurality of second vertices.

This makes it possible for the decoding device to determine whether to displace vertices based on the flag information.

A decoding device according to Example 8 includes a circuit and memory connected to the circuit, in which, in operation, the circuit: decodes, from a bitstream, (i) position information indicating positions of a plurality of first vertices included in a first three-dimensional mesh frame and (ii) a texture image; and by using positions of a plurality of second vertices generated from the position information, calculates texture coordinates indicating positions of the plurality of second vertices in the texture image.

The plurality of second vertices are generated as a result of subdivision of the first three-dimensional mesh frame, for example. This makes it possible to generate a mesh frame denser than the first three-dimensional mesh frame. By calculating texture coordinates based on the mesh frame generated in such a manner, that is, by determining the texture of the mesh frame, it is possible to determine the texture coordinates more finely than in the case of calculating the texture coordinates based on the plurality of first vertices. Accordingly, defects such as application of a wrong texture or no texture to the first three-dimensional mesh frame by a decoding process or the like can be inhibited.

A decoding device according to Example 9 is the decoding device according to Example 8, in which the circuit may further generate the plurality of second vertices by subdividing the first three-dimensional mesh frame.

This makes it possible to determine the texture coordinates more finely than in the case of calculating the texture coordinates based on the plurality of first vertices.

A decoding device according to Example 10 is the decoding device according to Example 8 or 9, in which the circuit may further: decode, from the bitstream, first count information indicating a total number of times the first three-dimensional mesh frame is subdivided to calculate the texture coordinates; and when calculating the texture coordinates, calculate the texture coordinates using the first count information.

This makes it possible to perform subdivisions the same number of times in encoding and decoding. Accordingly, the quality of the three-dimensional mesh frame reconstructed by the decoding device can be improved.

A decoding device according to Example 11 is the decoding device according to any one of Examples 8 to 10, in which the circuit may further: decode, from the bitstream, second count information indicating a total number of times the first three-dimensional mesh frame is subdivided to generate a second three-dimensional mesh frame from the first three-dimensional mesh frame; and generate the second three-dimensional mesh frame from the first three-dimensional mesh frame by using the texture coordinates and the second count information.

With this, for example, even when a difference exists between the total number of times the first three-dimensional mesh frame is subdivided to calculate texture coordinates and the total number of times the first three-dimensional mesh frame is subdivided to generate the second three-dimensional mesh frame from the first three-dimensional mesh frame, the encoding device and the decoding device can perform subdivisions the same number of times. Accordingly, the quality of the three-dimensional mesh frame reconstructed by the decoding device can be improved.

A decoding device according to Example 12 is the decoding device according to any one of Examples 8 to 11, in which the circuit may further: displace the plurality of second vertices; and when calculating the texture coordinates, calculate the texture coordinates based on the positions of the plurality of second vertices after displacement.

With this, even when vertices are displaced and then position information indicating the positions of the displaced vertices is encoded, the encoding device and the decoding device can calculate texture coordinates using vertices of the same positions.

A decoding device according to Example 13 is the decoding device according to any one of Examples 8 to 12, in which the circuit may decode, from the bitstream, flag information indicating whether to displace the plurality of second vertices.

This makes it possible for the decoding device to determine whether to displace vertices based on the flag information.

An encoding method according to Example 14 includes: based on positions of a plurality of second vertices generated based on positions of a plurality of first vertices included in a first three-dimensional mesh frame, calculating texture coordinates indicating positions of the plurality of second vertices in a two-dimensional coordinate system; and encoding, into a bitstream, (i) position information indicating the positions of the plurality of first vertices and (ii) a texture image that is in accordance with the texture coordinates.

With this, the same advantageous effects as those produced by the encoding device according to Example 1 are produced.

A decoding method according to Example 15 includes: decoding, from a bitstream, (i) position information indicating positions of a plurality of first vertices included in a first three-dimensional mesh frame and (ii) a texture image; and by using positions of a plurality of second vertices generated from the position information, calculating texture coordinates indicating positions of the plurality of second vertices in the texture image.

With this, the same advantageous effects as those produced by the decoding device according to Example 8 are produced.

Moreover, these general or specific aspects may be implemented using a system, a device, a method, an integrated circuit, a computer program, or a non-transitory computer-readable recording medium such as a CD-ROM, or any combination of systems, devices, methods, integrated circuits, computer programs, and recording media.

### Expressions and Terms

The following expressions and terms will be used herein.
(1) Three-dimensional mesh

A three-dimensional mesh is a set of a plurality of faces and indicates, for example, a three-dimensional object. In addition, a three-dimensional mesh is mainly constituted of vertex information, connection information, and attribute information. A three-dimensional mesh may be expressed as a polygon mesh or a mesh. In addition, a three-dimensional mesh may have a temporal change. A three-dimensional mesh may include metadata related to vertex information, connection information, and attribute information, or other additional information.
(2) Vertex information

Vertex information is information indicating a vertex. For example, vertex information indicates a position of a vertex in a three-dimensional space. In addition, a vertex corresponds to a vertex of a face that constitutes a three-dimensional mesh. Vertex information may be expressed as “geometry”. In addition, vertex information may also be expressed as position information.
(3) Connection information

Connection information is information indicating a connection between vertexes. For example, connection information indicates a connection for constructing a face or an edge of a three-dimensional mesh. Connection information may be expressed as “connectivity”. In addition, connection information may also be expressed as face information.
(4) Attribute information

Attribute information is information indicating an attribute of a vertex or a face. For example, attribute information indicates an attribute such as a color, an image, a normal vector, and the like associated with a vertex or a face. Attribute information may be expressed as “texture”.
(5) Face

A face is an element that constitutes a three-dimensional mesh. Specifically, a face is a polygon on a plane in a three-dimensional space. For example, a face can be determined as a triangle in the three-dimensional space.
(6) Plane

A plane is a two-dimensional plane in a three-dimensional space. For example, a polygon is formed on a plane and a plurality of polygons are formed on a plurality of planes.
(7) Bitstream

A bitstream corresponds to encoded information. A bitstream can also be expressed as a stream, an encoded bitstream, a compressed bitstream, or an encoded signal.
(8) Encoding and decoding

The expression “encode” may be replaced with expressions such as store, include, write, describe, signalize, send out, notify, save, or compress and such expressions may be interchangeably used. For example, encoding information may mean including information in a bitstream. In addition, encoding information in a bitstream may mean encoding the information and generating a bitstream that includes the encoded information.

In addition, the expression “decode” may be replaced with expressions such as read, interpret, scan, load, derive, acquire (obtain), receive, extract, restore, reconstruct, decompress, or expand and such expressions may be interchangeably used. For example, decoding information may mean acquiring information from a bitstream. In addition, decoding information from a bitstream may mean decoding the bitstream and acquiring information included in the bitstream.
(9) Ordinal numbers

In the description, an ordinal number such as first, second, or the like may be affixed to a constituent element or the like. Such ordinal numbers may be replaced as necessary. In addition, an ordinal number may be newly affixed to or removed from a constituent element or the like. Furthermore, the ordinal numbers may be affixed to elements in order to identify the elements and may not correspond to any meaningful order.

### Three-Dimensional Mesh

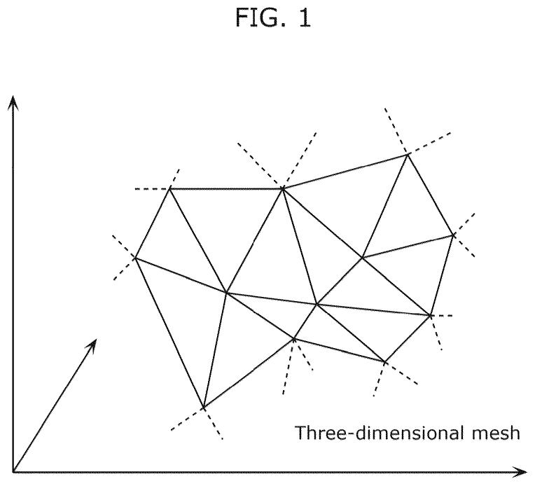

FIG. 1 is a conceptual diagram illustrating a three-dimensional mesh according to the present embodiment. The three-dimensional mesh is constituted of a plurality of faces. For example, each face is a triangle. Vertexes of the triangles are determined in a three-dimensional space. In addition, a three-dimensional mesh indicates a three-dimensional object. Each face may have a color or an image.

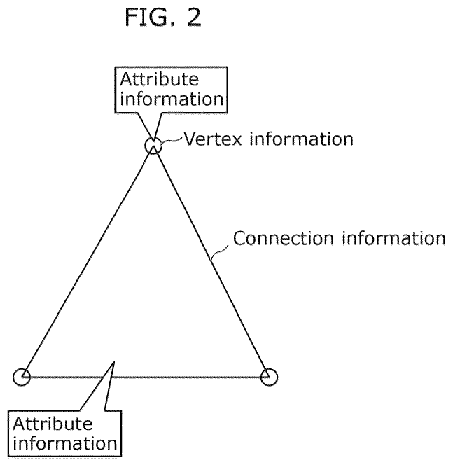

FIG. 2 is a conceptual diagram illustrating basic elements of a three-dimensional mesh according to the present embodiment. The three-dimensional mesh is constituted of vertex information, connection information, and attribute information. Vertex information indicates a position of a vertex of a face in a three-dimensional space. Connection information indicates a connection between vertexes. A face can be identified based on vertex information and connection information. In other words, an uncolored three-dimensional object is formed in a three-dimensional space based on vertex information and connection information.

Attribute information may be associated with a vertex or associated with a face. Attribute information associated with a vertex may be expressed as “attribute per point”. Attribute information associated with a vertex may indicate an attribute of the vertex itself or indicate an attribute of a face connected to the vertex.

For example, a color may be associated with a vertex as attribute information. The color associated with the vertex may be the color of the vertex or the color of a face connected to the vertex. The color of the face may be an average of a plurality of colors associated with a plurality of vertexes of the face. In addition, a normal vector may be associated with a vertex or a face as attribute information. Such a normal vector can express a front and a rear of a face.

In addition, a two-dimensional image may be associated with a face as attribute information. The two-dimensional image associated with a face is also expressed as a texture image or an “attribute map”. In addition, information indicating mapping between a face and a two-dimensional image may be associated with the face as attribute information. Such information indicating mapping may be expressed as mapping information, vertex information of a texture image, texture coordinates, or an “attribute UV coordinate”.

Furthermore, information on a color, an image, a moving image, and the like to be used as attribute information may be expressed as “parametric space”.

A texture can be reflected in a three-dimensional object based on such attribute information. In other words, a colored three-dimensional object is formed in a three-dimensional space based on vertex information, connection information, and attribute information.

Note that while attribute information is associated with a vertex or a face in the description given above, alternatively, attribute information may be associated with an edge.

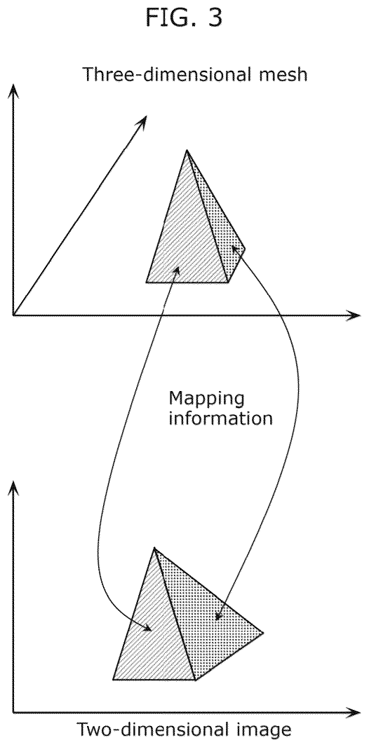

FIG. 3 is a conceptual diagram illustrating mapping according to the present embodiment. For example, a region of a two-dimensional image on a two-dimensional plane can be mapped to a face of a three-dimensional mesh in a three-dimensional space. Specifically, coordinate information of a region in the two-dimensional image is associated with a face of the three-dimensional mesh. Accordingly, an image of the mapped region in the two-dimensional image is reflected in the face of the three-dimensional mesh.

With use of mapping, a two-dimensional image to be used as attribute information can be separated from the three-dimensional mesh. For example, in encoding of the three-dimensional mesh, the two-dimensional image may be encoded based on an image encoding system or a video encoding system.

### System Configuration

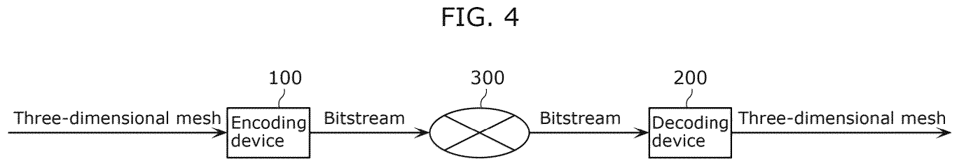

FIG. 4 is a block diagram illustrating a configuration example of an encoding and decoding system according to the present embodiment. In FIG. 4, the encoding and decoding system includes encoding device 100 and decoding device 200.

For example, encoding device 100 acquires a three-dimensional mesh and encodes the three-dimensional mesh into a bitstream. In addition, encoding device 100 outputs the bitstream to network 300. For example, the bitstream includes an encoded three-dimensional mesh and control information for decoding the encoded three-dimensional mesh. Encoding of the three-dimensional mesh causes information of the three-dimensional mesh to be compressed.

Network 300 transmits the bitstream from encoding device 100 to decoding device 200. Network 300 may be the Internet, a wide area network (WAN), a local area network (LAN), or a combination thereof. Network 300 is not necessarily limited to two-way communication and may be a unidirectional communication network for terrestrial digital broadcasting, satellite broadcasting, or the like.

In addition, network 300 may be replaced with a recording medium such as a digital versatile disc (DVD), a Blu-Ray Disc (registered trademark) (BD), or the like.

Decoding device 200 acquires a bitstream and decodes a three-dimensional mesh from the bitstream. Decoding of the three-dimensional mesh causes information of the three-dimensional mesh to be expanded. For example, decoding device 200 decodes a three-dimensional mesh according to a decoding method corresponding to an encoding method used by encoding device 100 to encode the three-dimensional mesh. In other words, encoding device 100 and decoding device 200 perform encoding and decoding according to an encoding method and a decoding method which correspond to each other.

Note that the three-dimensional mesh before encoding can also be expressed as an original three-dimensional mesh. In addition, the three-dimensional mesh after decoding is also expressed as a reconstructed three-dimensional mesh.

### Encoding Device

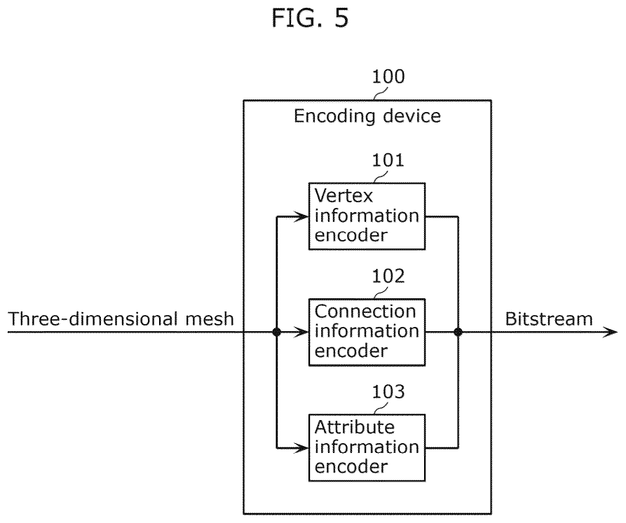

FIG. 5 is a block diagram illustrating a configuration example of encoding device 100 according to the present embodiment. For example, encoding device 100 includes vertex information encoder 101, connection information encoder 102, and attribute information encoder 103.

Vertex information encoder 101 is an electric circuit which encodes vertex information. For example, vertex information encoder 101 encodes vertex information into a bitstream according to a format defined with respect to the vertex information.

Connection information encoder 102 is an electric circuit which encodes connection information. For example, connection information encoder 102 encodes connection information into a bitstream according to a format defined with respect to the connection information.

Attribute information encoder 103 is an electric circuit which encodes attribute information. For example, attribute information encoder 103 encodes attribute information into a bitstream according to a format defined with respect to the attribute information.

Variable-length coding or fixed length coding may be used for encoding vertex information, connection information, and attribute information. The variable-length coding may accommodate Huffman coding, context-adaptive binary arithmetic coding (CABAC), or the like.

Vertex information encoder 101, connection information encoder 102, and attribute information encoder 103 may be integrated. Alternatively, each of vertex information encoder 101, connection information encoder 102, and attribute information encoder 103 may be more finely segmentalized into a plurality of constituent elements.

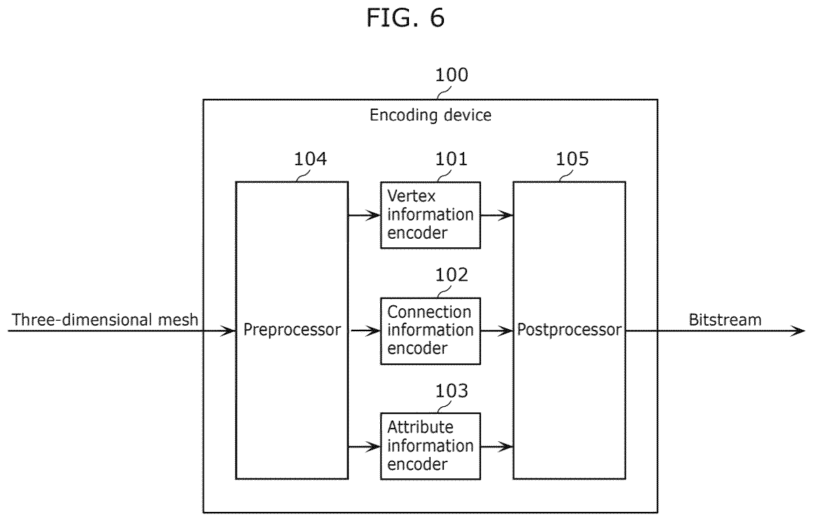

FIG. 6 is a block diagram illustrating another configuration example of encoding device 100 according to the present embodiment. For example, in addition to the configuration illustrated in FIG. 5, encoding device 100 includes preprocessor 104 and postprocessor 105.

Preprocessor 104 is an electric circuit which performs processing before encoding of vertex information, connection information, and attribute information. For example, preprocessor 104 may perform transformation processing, demultiplexing, multiplexing, or the like with respect to a three-dimensional mesh before encoding. More specifically, for example, preprocessor 104 may demultiplex vertex information, connection information, and attribute information from the three-dimensional mesh before encoding.

Postprocessor 105 is an electric circuit which performs processing after the encoding of vertex information, connection information, and attribute information. For example, postprocessor 105 may perform transformation processing, demultiplexing, multiplexing, or the like with respect to vertex information, connection information, and attribute information after encoding. More specifically, for example, postprocessor 105 may multiplex vertex information, connection information, and attribute information after encoding into a bitstream. In addition, for example, postprocessor 105 may further perform variable-length coding with respect to vertex information, connection information, and attribute information after the encoding.

### Decoding Device

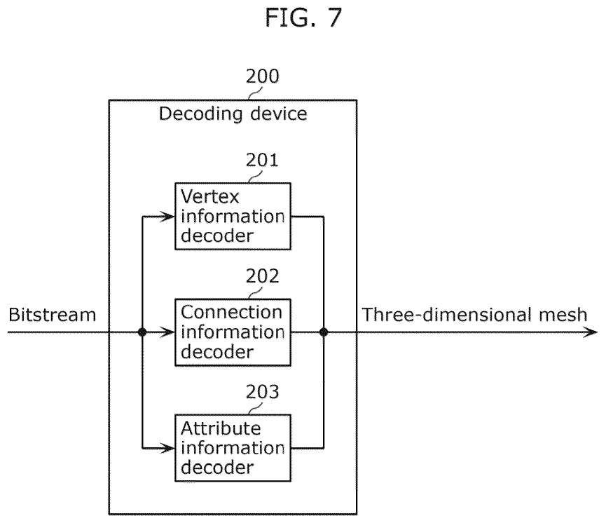

FIG. 7 is a block diagram illustrating a configuration example of decoding device 200 according to the present embodiment. For example, decoding device 200 includes vertex information decoder 201, connection information decoder 202, and attribute information decoder 203.

Vertex information decoder 201 is an electric circuit which decodes vertex information. For example, vertex information decoder 201 decodes vertex information from a bitstream according to a format defined with respect to the vertex information.

Connection information decoder 202 is an electric circuit which decodes connection information. For example, connection information decoder 202 decodes connection information from a bitstream according to a format defined with respect to the connection information.

Attribute information decoder 203 is an electric circuit which decodes attribute information. For example, attribute information decoder 203 decodes attribute information from a bitstream according to a format defined with respect to the attribute information.

Variable-length decoding or fixed length decoding may be used for decoding vertex information, connection information, and attribute information. The variable-length decoding may accommodate Huffman coding, context-adaptive binary arithmetic coding (CABAC), or the like.

Vertex information decoder 201, connection information decoder 202, and attribute information decoder 203 may be integrated. Alternatively, each of vertex information decoder 201, connection information decoder 202, and attribute information decoder 203 may be more finely segmentalized into a plurality of constituent elements.

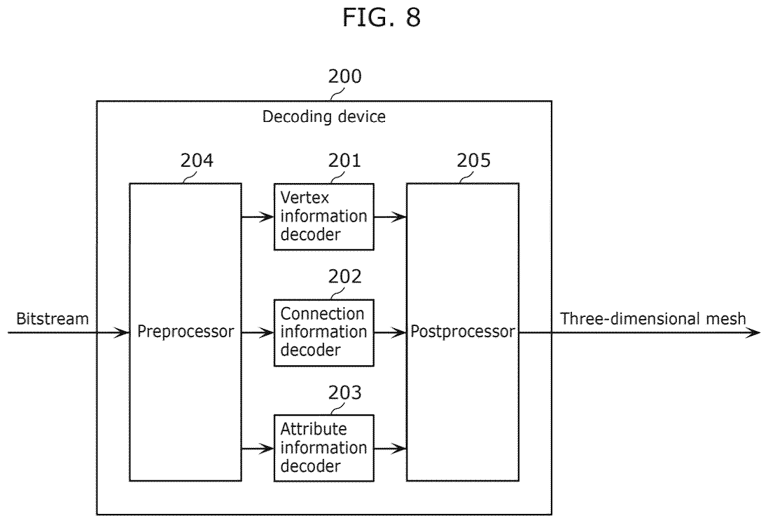

FIG. 8 is a block diagram illustrating another configuration example of decoding device 200 according to the present embodiment. For example, in addition to the components illustrated in FIG. 7, decoding device 200 includes preprocessor 204 and postprocessor 205.

Preprocessor 204 is an electric circuit which performs processing before decoding of vertex information, connection information, and attribute information. For example, preprocessor 204 may perform transformation processing, demultiplexing, multiplexing, or the like with respect to a bitstream before decoding of vertex information, connection information, and attribute information.

More specifically, for example, preprocessor 204 may demultiplex, from a bitstream, a sub-bitstream corresponding to vertex information, a sub-bitstream corresponding to connection information, and a sub-bitstream corresponding to attribute information. In addition, for example, preprocessor 204 may perform variable-length decoding with respect to the bitstream in advance before decoding of vertex information, connection information, and attribute information.

Postprocessor 205 is an electric circuit which performs processing after the decoding of vertex information, connection information, and attribute information. For example, postprocessor 205 may perform transformation processing, demultiplexing, multiplexing, or the like with respect to vertex information, connection information, and attribute information after decoding. More specifically, for example, postprocessor 205 may multiplex vertex information, connection information, and attribute information after decoding into a three-dimensional mesh.

### Bitstream

Vertex information, connection information, and attribute information are encoded and stored in a bitstream. A relationship between these pieces of information and the bitstream will be described below.

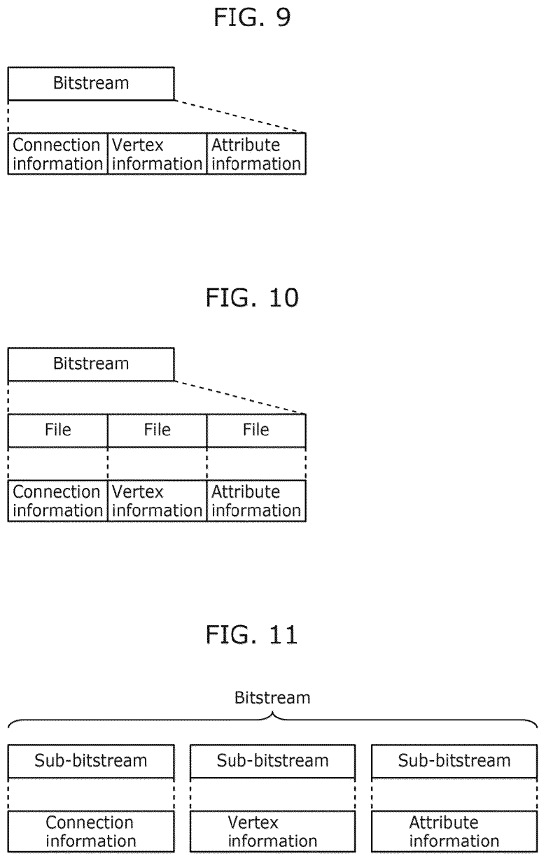

FIG. 9 is a conceptual diagram illustrating a configuration example of a bitstream according to the present embodiment. In this example, connection information, vertex information, and attribute information are integrated in the bitstream. For example, connection information, vertex information, and attribute information may be included in one file.

In addition, a plurality of portions of the pieces of information may be sequentially stored such as a first portion of connection information, a first portion of vertex information, a first portion of attribute information, a second portion of connection information, a second portion of vertex information, a second portion of attribute information, . . . The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

FIG. 10 is a conceptual diagram illustrating another configuration example of a bitstream according to the present embodiment. In the example, a plurality of files are included in a bitstream and connection information, vertex information, and attribute information are respectively stored in different files. While a file including connection information, a file including vertex information, and a file including attribute information are illustrated here, storage formats are not limited to this example. For example, two types of information among connection information, vertex information, and attribute information may be included in one file and the one remaining type of information may be included in another file.

Alternatively, the pieces of information can be stored by being divided into a larger number of files. For example, a plurality of portions of connection information may be stored in a plurality of files, a plurality of portions of vertex information may be stored in a plurality of files, and a plurality of portions of attribute information may be stored in a plurality of files. The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

FIG. 11 is a conceptual diagram illustrating another configuration example of a bitstream according to the present embodiment. In the example, a bitstream is constituted of a plurality of separable sub-bitstreams and connection information, vertex information, and attribute information are respectively stored in different sub-bitstreams.

While a sub-bitstream including connection information, a sub-bitstream including vertex information, and a sub-bitstream including attribute information are illustrated here, storage formats are not limited to this example.

For example, two types of information among connection information, vertex information, and attribute information may be included in one sub-bitstream and the one remaining type of information may be included in another sub-bitstream. Specifically, attribute information such as a two-dimensional image may be stored in a sub-bitstream conforming to an image coding system separately from a sub-bitstream of connection information and vertex information.

In addition, each sub-bitstream may include a plurality of files. Furthermore, a plurality of portions of connection information may be stored in a plurality of files, a plurality of portions of vertex information may be stored in a plurality of files, and a plurality of portions of attribute information may be stored in a plurality of files.

Furthermore, an order of storage of connection information, vertex information, and attribute information is not limited to the example illustrated in FIG. 9, FIG. 10, and FIG. 11, and an order of storage that differs from this example may be used. For example, vertex information, connection information, and attribute information may be stored in a bitstream in this order. Alternatively, in an order other than this order, e.g., in any of orders: connection information, attribute information, and vertex information; vertex information, attribute information, and connection information; attribute information, connection information, and vertex information; and attribute information, vertex information, and connection information, these pieces of information may be stored in a bitstream.

Furthermore, each of connection information, vertex information, and attribute information may be divided into a plurality of data items, and the plurality of data items may be stored in a bitstream in a periodic order or in a random order.

### Specific Example

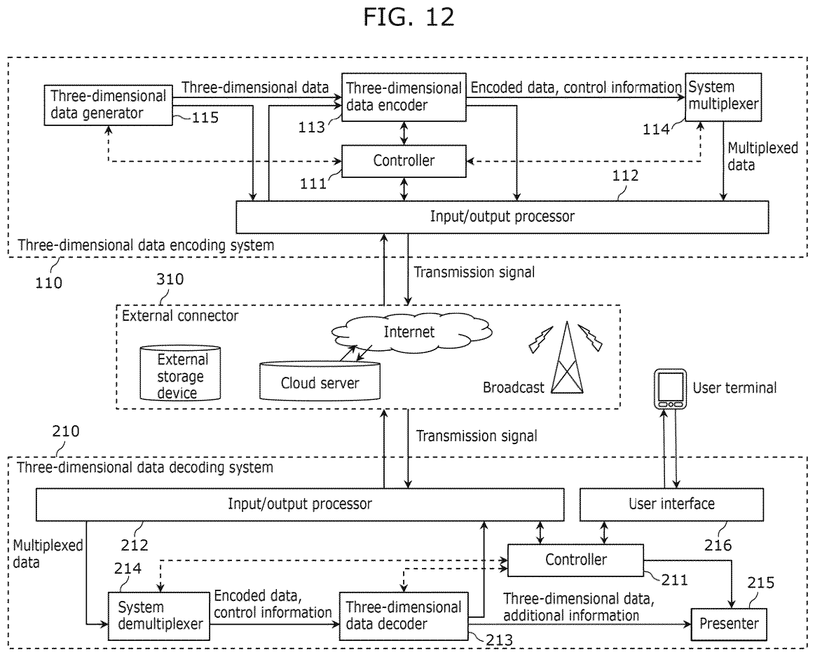

FIG. 12 is a block diagram illustrating a specific example of the encoding and decoding system according to the present embodiment. In FIG. 12, the encoding and decoding system includes three-dimensional data encoding system 110, three-dimensional data decoding system 210, and external connector 310.

Three-dimensional data encoding system 110 includes controller 111, input/output processor 112, three-dimensional data encoder 113, three-dimensional data generator 115, and system multiplexer 114. Three-dimensional data decoding system 210 includes controller 211, input/output processor 212, three-dimensional data decoder 213, system demultiplexer 214, presenter 215, and user interface 216.

In three-dimensional data encoding system 110, sensor data is input from a sensor terminal to three-dimensional data generator 115. Three-dimensional data generator 115 generates three-dimensional data that is point cloud data, mesh data, or the like from the sensor data and inputs the three-dimensional data to three-dimensional data encoder 113.

For example, three-dimensional data generator 115 generates vertex information and generates connection information and attribute information which correspond to the vertex information. Three-dimensional data generator 115 may process vertex information when generating connection information and attribute information. For example, three-dimensional data generator 115 may reduce a data amount by deleting overlapping vertexes or transform vertex information (position shift, rotation, normalization, or the like). In addition, three-dimensional data generator 115 may render attribute information.

While three-dimensional data generator 115 is a constituent element of three-dimensional data encoding system 110 in FIG. 12, three-dimensional data generator 115 may be disposed on the outside independent of three-dimensional data encoding system 110.

For example, a sensor terminal that provides sensor data for generating three-dimensional data may be a mobile object such as an automobile, a flying object such as an airplane, a mobile terminal, a camera, or the like. Alternatively, a range sensor such as LIDAR, a millimeter-wave radar, an infrared sensor, or a range finder, a stereo camera, a combination of a plurality of monocular cameras, or the like may be used as the sensor terminal.

The sensor data may be a distance (position) of an object, a monocular camera image, a stereo camera image, a color, a reflectance, an attitude or an orientation of a sensor, a gyro, a sensing position (GPS information or elevation), a velocity, an acceleration, a time of day of sensing, air temperature, air pressure, humidity, magnetism, or the like.

Three-dimensional data encoder 113 corresponds to encoding device 100 illustrated in FIG. 5 and the like. For example, three-dimensional data encoder 113 encodes three-dimensional data and generates encoded data. In addition, three-dimensional data encoder 113 generates control information when encoding the three-dimensional data. Furthermore, three-dimensional data encoder 113 inputs the encoded data to system multiplexer 114 together with the control information.

The encoding system of three-dimensional data may be an encoding system using geometry or an encoding system using a video codec. In this case, an encoding system using geometry may also be expressed as a geometry-based encoding system. An encoding system using a video codec may also be expressed as a video-based encoding system.

System multiplexer 114 multiplexes encoded data and control information input from three-dimensional data encoder 113 and generates multiplexed data using a prescribed multiplexing system. System multiplexer 114 may multiplex other media such as video, audio, subtitles, application data, or document files, reference time information, or the like together with the encoded data and control information of three-dimensional data. Furthermore, system multiplexer 114 may multiplex attribute information related to sensor data or three-dimensional data.

For example, multiplexed data has a file format for accumulation, a packet format for transmission, or the like. ISOBMFF or an ISOBMFF-based system may be used as an accumulation system or a transmission system. Alternatively, MPEG-DASH, MMT, MPEG-2 TS Systems, RTP, or the like may be used.

In addition, multiplexed data is output as a transmission signal by input/output processor 112 to external connector 310. The multiplexed data may be transmitted as a transmission signal in a wired manner or in a wireless manner. Alternatively, the multiplexed data is accumulated in an internal memory or a storage device. The multiplexed data may be transmitted via the Internet to a cloud server or stored in an external storage device.

For example, the transmission or accumulation of the multiplexed data is performed by a method in accordance with a medium for transmission or accumulation such as broadcasting or communication. As a communication protocol, http, ftp, TCP, UDP, IP, or a combination thereof may be used. In addition, a pull-type communication scheme may be used or a push-type communication scheme may be used.

Ethernet (registered trademark), USB, RS-232C, HDMI (registered trademark), a coaxial cable, or the like may be used for wired transmission. In addition, 3GPP (registered trademark), 3G/4G/5G as specified by IEEE, a wireless LAN, Bluetooth, or a millimeter-wave may be used for wireless transmission. Furthermore, for example, DVB-T2, DVB-S2, DVB-C2, ATSC 3.0, ISDB-S3, or the like may be used as a broadcasting system.

Note that sensor data may be input to three-dimensional data generator 115 or system multiplexer 114. In addition, three-dimensional data or encoded data may be output as-is as a transmission signal to external connector 310 via input/output processor 112. The transmission signal output from three-dimensional data encoding system 110 is input to three-dimensional data decoding system 210 via external connector 310.

In addition, each operation of three-dimensional data encoding system 110 may be controlled by controller 111 which executes application programs.

In three-dimensional data decoding system 210, a transmission signal is input to input/output processor 212. Input/output processor 212 decodes multiplexed data having a file format or a packet format from the transmission signal and inputs the multiplexed data to system demultiplexer 214. System demultiplexer 214 acquires encoded data and control information from the multiplexed data and inputs the encoded data and the control information to three-dimensional data decoder 213. System demultiplexer 214 may extract other media, reference time information, or the like from the multiplexed data.

Three-dimensional data decoder 213 corresponds to decoding device 200 illustrated in FIG. 7 and the like. For example, three-dimensional data decoder 213 decodes three-dimensional data from the encoded data based on an encoding system specified in advance. Subsequently, the three-dimensional data is presented to a user by presenter 215.

In addition, additional information such as sensor data may be input to presenter 215. Presenter 215 may present three-dimensional data based on the additional information. In addition, an instruction by the user may be input to user interface 216 from a user terminal. Furthermore, presenter 215 may present three-dimensional data based on the input instruction.

Note that input/output processor 212 may acquire three-dimensional data and encoded data from external connector 310.

In addition, each operation of three-dimensional data decoding system 210 may be controlled by controller 211 which executes application programs.

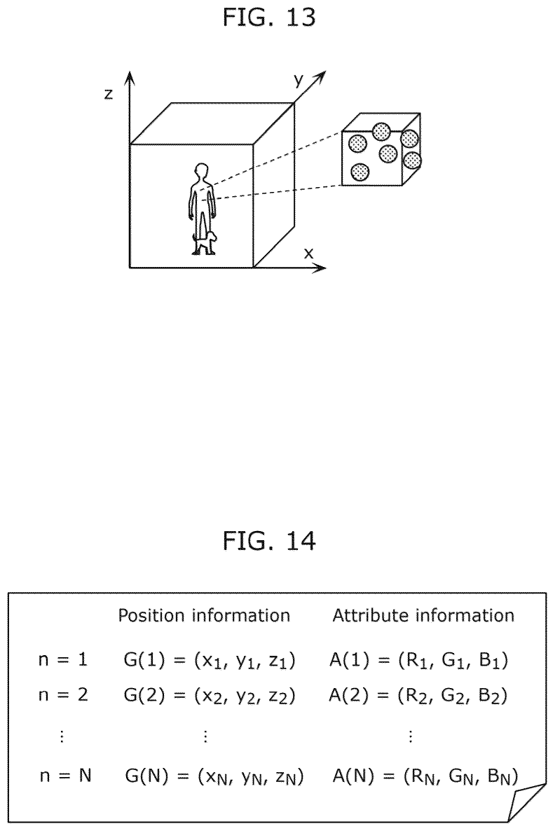

FIG. 13 is a conceptual diagram illustrating a configuration example of point cloud data according to the present embodiment. Point cloud data refers to data of a point cloud that indicates a three-dimensional object.

Specifically, a point cloud is constituted of a plurality of points and has position information which indicates a three-dimensional coordinate position of each point and attribute information which indicates an attribute of each point. The position information is also expressed as geometry.

For example, a type of attribute information may be a color, a reflectance, or the like. Attribute information related to one type may be associated with one point, attribute information related to a plurality of different types may be associated with one point, or attribute information having a plurality of values with respect to a same type may be associated with one point.

FIG. 14 is a conceptual diagram illustrating a data file example of the point cloud data according to the present embodiment. The example is an example of a case where items of position information and items of attribute information have a one-to-one correspondence and the example indicates position information and attribute information of N-number of points which constitute the point cloud data. In this example, position information is information indicating a three-dimensional coordinate position by three axes of x, y, and z and attribute information is information indicating a color by RGB. As a representative data file of point cloud data, a PLY file or the like can be used.

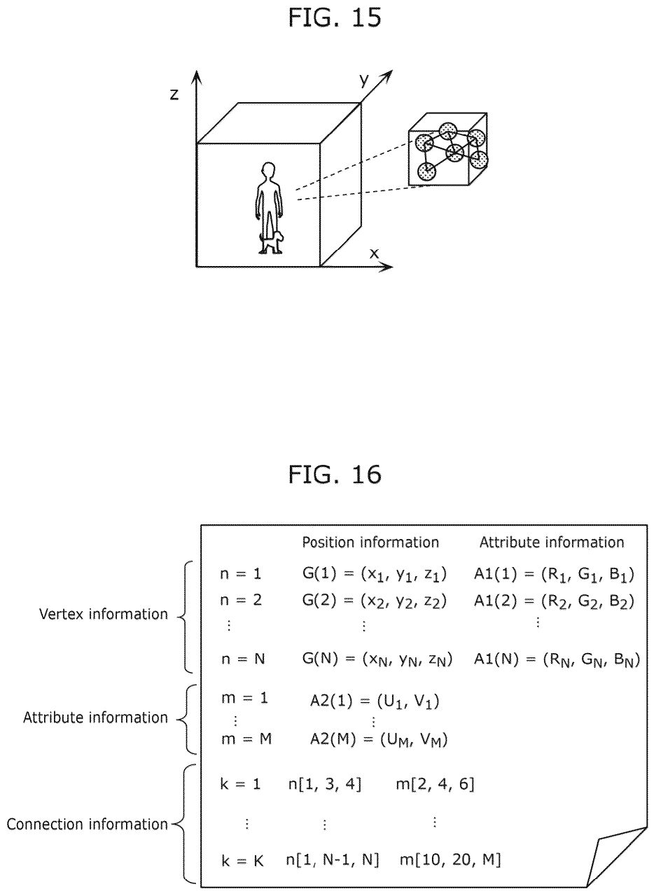

FIG. 15 is a conceptual diagram illustrating a configuration example of mesh data according to the present embodiment. Mesh data is data used in CG (computer graphics) or the like and is data of a three-dimensional mesh which represents a three-dimensional shape of an object by a plurality of faces. Each face is also expressed as a polygon and has a polygonal shape such as a triangle or a quadrilateral.

Specifically, in addition to the plurality of points which constitute a point cloud, a three-dimensional mesh is constituted of a plurality of edges and a plurality of faces. Each point is also expressed as a vertex or a position. Each edge corresponds to a line segment which connects two vertexes. Each face corresponds to an area enclosed by three or more edges.

In addition, a three-dimensional mesh has position information indicating three-dimensional coordinate positions of vertexes. The position information is also expressed as vertex information or geometry. Furthermore, a three-dimensional mesh has connection information indicating a relationship among a plurality of vertexes constituting an edge or a face. The connection information is also expressed as connectivity. In addition, a three-dimensional mesh has attribute information indicating an attribute with respect to a vertex, an edge, or a face. The attribute information in a three-dimensional mesh is also expressed as a texture.

For example, attribute information may indicate a color, a reflectance, or a normal vector with respect to a vertex, an edge, or a face. An orientation of a normal vector can express a front and a rear of a face.

An object file or the like may be used as a data file format of mesh data.

FIG. 16 is a conceptual diagram illustrating a data file example of the mesh data according to the present embodiment. In the example, a data file includes pieces of position information G(1) to G(N) and pieces of attribute information A1(1) to A1(N) of N-number of vertexes which constitute a three-dimensional mesh. In addition, in the example, M-number of pieces of attribute information A2(1) to A2(M) are included. An item of attribute information need not correspond one-to-one to a vertex and need not correspond one-to-one to a face. In addition, attribute information need not exist.

Connection information is indicated by a combination of indexes of vertexes. n [1, 3, 4] indicates a face of a triangle constituted of three vertexes n=1, n=3, and n=4. In addition, m[2, 4, 6] indicates that pieces of attribute information m=2, m=4, and m=6 respectively correspond to the three vertexes.

In addition, a substantive content of the attribute information may be described in a separate file. Furthermore, a pointer with respect to the content may be associated with a vertex, a face, or the like. For example, attribute information indicating an image with respect to a face may be stored in a two-dimensional attribute map file. In addition, a file name of the attribute map and a two-dimensional coordinate value in the attribute map may be described in pieces of attribute information A2(1) to A2(M). Methods of designating attribute information with respect to a face are not limited to these methods and any kind of method may be used.

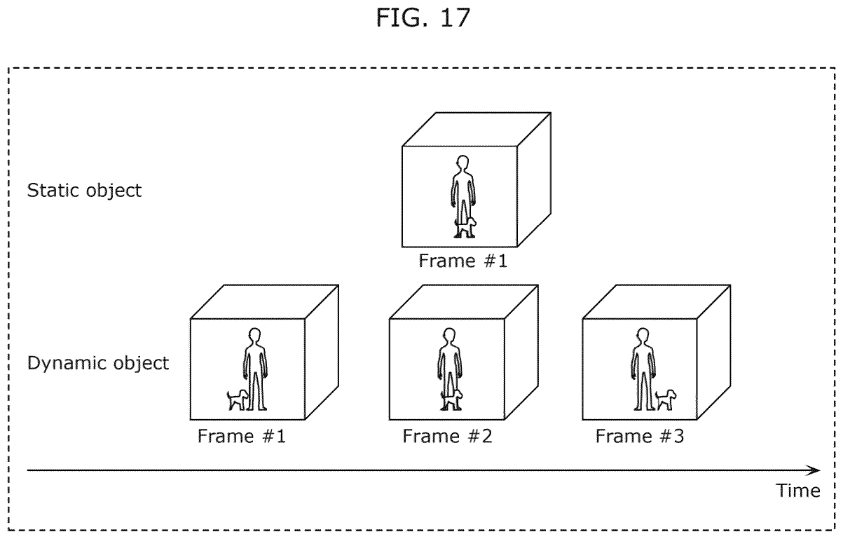

FIG. 17 is a conceptual diagram illustrating a type of three-dimensional data according to the present embodiment. Point cloud data and mesh data may either indicate a static object or a dynamic object. A static object is an object that does not temporally change, and a dynamic object is an object that temporally changes. A static object may correspond to three-dimensional data with respect to an arbitrary time point.

For example, point cloud data with respect to an arbitrary time point may be expressed as a PCC frame. In addition, mesh data with respect to an arbitrary time point may be expressed as a mesh frame. Furthermore, a PCC frame and a mesh frame may be simply expressed as a frame.

In addition, an area of an object may be limited to a certain range in a similar manner to ordinary video data or need not be limited in a similar manner to map data. Furthermore, a density of points or faces may be set in various ways. Sparse point cloud data or sparse mesh data may be used, or dense point cloud data or dense mesh data may be used.

Next, encoding and decoding of a point cloud or a three-dimensional mesh will be described. A device, processing, or a syntax for encoding and decoding vertex information of a three-dimensional mesh according to the present disclosure may be applied to the encoding and decoding of a point cloud. A device, processing, or a syntax for encoding and decoding a point cloud according to the present disclosure may be applied to the encoding and decoding of vertex information of a three-dimensional mesh.

In addition, a device, processing, or a syntax for encoding and decoding attribute information of a point cloud according to the present disclosure may be applied to the encoding and decoding of connection information or attribute information of a three-dimensional mesh. Furthermore, a device, processing, or a syntax for encoding and decoding connection information or attribute information of a three-dimensional mesh according to the present disclosure may be applied to the encoding and decoding of attribute information of a point cloud.

Furthermore, at least a part of processing may be commonalized between the encoding and decoding of point cloud data and the encoding and decoding of mesh data. Accordingly, sizes of circuits and software programs can be suppressed.

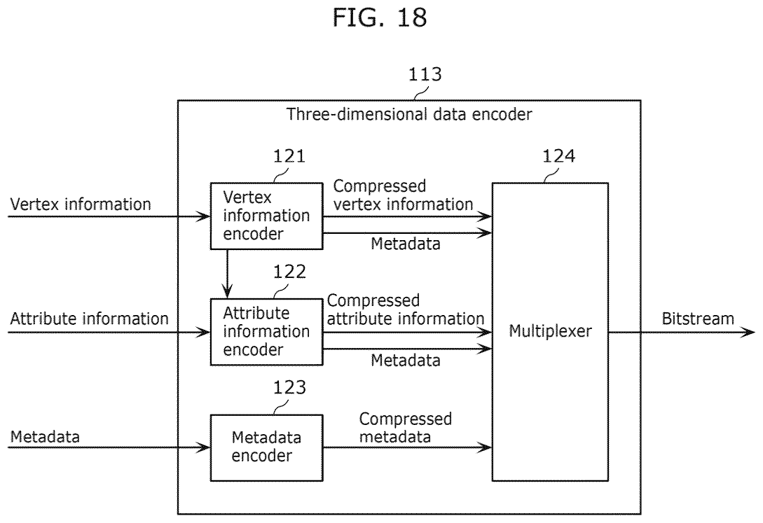

FIG. 18 is a block diagram illustrating a configuration example of three-dimensional data encoder 113 according to the present embodiment. In this example, three-dimensional data encoder 113 includes vertex information encoder 121, attribute information encoder 122, metadata encoder 123, and multiplexer 124. Vertex information encoder 121, attribute information encoder 122, and multiplexer 124 may correspond to vertex information encoder 101, attribute information encoder 103, postprocessor 105, and the like illustrated in FIG. 6.

In addition, in this example, three-dimensional data encoder 113 encodes three-dimensional data according to a geometry-based encoding system. Encoding according to the geometry-based encoding system takes a three-dimensional structure into consideration. Furthermore, in encoding according to the geometry-based encoding system, attribute information is encoded using configuration information obtained during encoding of vertex information.

Specifically, first, vertex information, attribute information, and metadata included in three-dimensional data generated from sensor data are respectively input to vertex information encoder 121, attribute information encoder 122, and metadata encoder 123. In this case, connection information included in three-dimensional data may be handled in a similar manner to attribute information. In addition, in the case of point cloud data, position information may be handled as vertex information.

Vertex information encoder 121 encodes vertex information into compressed vertex information and outputs the compressed vertex information to multiplexer 124 as encoded data. In addition, vertex information encoder 121 generates metadata of the compressed vertex information and outputs the metadata to multiplexer 124. Furthermore, vertex information encoder 121 generates configuration information and outputs the configuration information to attribute information encoder 122.

Attribute information encoder 122 encodes attribute information into compressed attribute information using the configuration information generated by vertex information encoder 121 and outputs the compressed attribute information to multiplexer 124 as encoded data. In addition, attribute information encoder 122 generates metadata of the compressed attribute information and outputs the metadata to multiplexer 124.

Metadata encoder 123 encodes compressible metadata into compressed metadata and outputs the compressed metadata to multiplexer 124 as encoded data. The metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

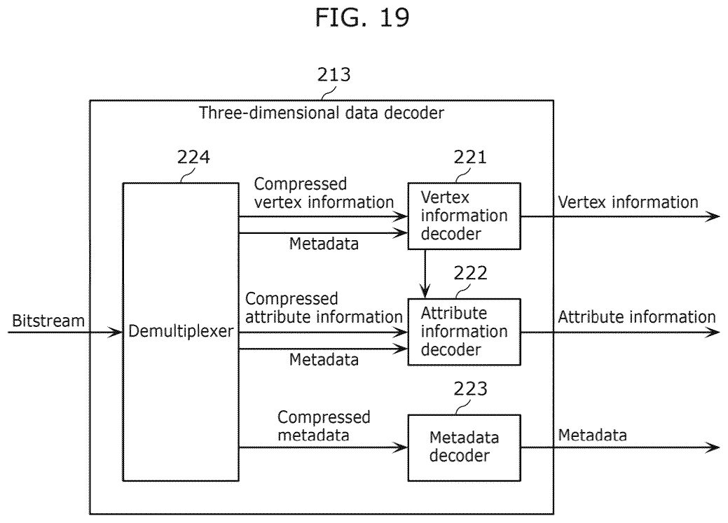

FIG. 19 is a block diagram illustrating a configuration example of three-dimensional data decoder 213 according to the present embodiment. In this example, three-dimensional data decoder 213 includes vertex information decoder 221, attribute information decoder 222, metadata decoder 223, and demultiplexer 224. Vertex information decoder 221, attribute information decoder 222, and demultiplexer 224 may correspond to vertex information decoder 201, attribute information decoder 203, preprocessor 204, and the like illustrated in FIG. 8.

In addition, in this example, three-dimensional data decoder 213 decodes three-dimensional data according to a geometry-based encoding system. Decoding according to the geometry-based encoding system takes a three-dimensional structure into consideration. Furthermore, in decoding according to the geometry-based encoding system, attribute information is decoded using configuration information obtained during decoding of vertex information.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information and the metadata of the compressed vertex information are input to vertex information decoder 221. The compressed attribute information and the metadata of the compressed attribute information are input to attribute information decoder 222. The metadata is input to metadata decoder 223.

Vertex information decoder 221 decodes vertex information from the compressed vertex information using the metadata of the compressed vertex information. In addition, vertex information decoder 221 generates configuration information and outputs the configuration information to attribute information decoder 222. Attribute information decoder 222 decodes attribute information from the compressed attribute information using the configuration information generated by vertex information decoder 221 and the metadata of the compressed attribute information. Metadata decoder 223 decodes metadata from the compressed metadata. The metadata decoded by metadata decoder 223 may be used to decode vertex information and to decode attribute information.

Subsequently, the vertex information, the attribute information, and the metadata are output from three-dimensional data decoder 213 as three-dimensional data. For example, the metadata is metadata of vertex information and attribute information and can be used in an application program.

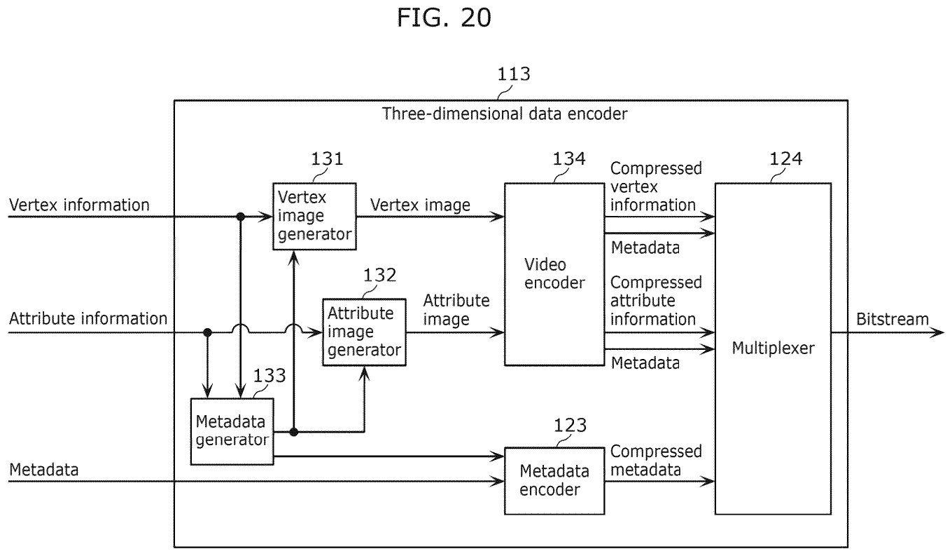

FIG. 20 is a block diagram illustrating another configuration example of three-dimensional data encoder 113 according to the present embodiment. In this example, three-dimensional data encoder 113 includes vertex image generator 131, attribute image generator 132, metadata generator 133, video encoder 134, metadata encoder 123, and multiplexer 124. Vertex image generator 131, attribute image generator 132, and video encoder 134 may correspond to vertex information encoder 101, attribute information encoder 103, and the like illustrated in FIG. 6.

In addition, in this example, three-dimensional data encoder 113 encodes three-dimensional data according to a video-based encoding system. In encoding according to the video-based encoding system, a plurality of two-dimensional images are generated from three-dimensional data and the plurality of two-dimensional images are encoded according to a video encoding system. In this case, the video encoding system may be HEVC (high efficiency video coding), VVC (versatile video coding), or the like.

Specifically, first, vertex information and attribute information included in three-dimensional data generated from sensor data are input to metadata generator 133. In addition, the vertex information and the attribute information are respectively input to vertex image generator 131 and attribute image generator 132. Furthermore, the metadata included in the three-dimensional data is input to metadata encoder 123. In this case, connection information included in three-dimensional data may be handled in a similar manner to attribute information. In addition, in the case of point cloud data, position information may be handled as vertex information.

Metadata generator 133 generates map information of a plurality of two-dimensional images from the vertex information and the attribute information. In addition, metadata generator 133 inputs the map information into vertex image generator 131, attribute image generator 132, and metadata encoder 123.

Vertex image generator 131 generates a vertex image based on the vertex information and the map information and inputs the vertex image into video encoder 134. Attribute image generator 132 generates an attribute image based on the attribute information and the map information and inputs the attribute image into video encoder 134.

Video encoder 134 respectively encodes the vertex image and the attribute image into compressed vertex information and compressed attribute information according to the video encoding system and outputs the compressed vertex information and the compressed attribute information to multiplexer 124 as encoded data. In addition, video encoder 134 generates metadata of the compressed vertex information and metadata of the compressed attribute information and outputs the pieces of metadata to multiplexer 124.

Metadata encoder 123 encodes compressible metadata into compressed metadata and outputs the compressed metadata to multiplexer 124 as encoded data. Compressible metadata includes map information. In addition, the metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

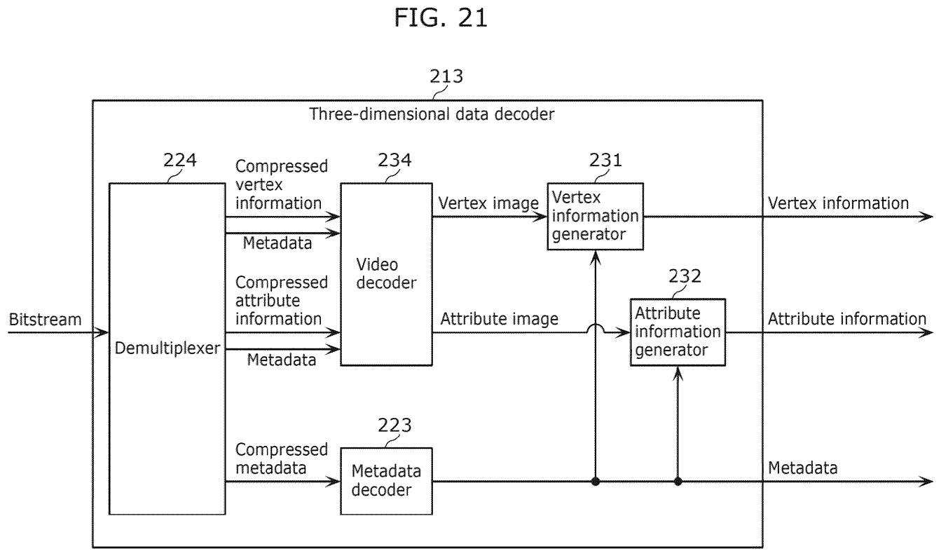

FIG. 21 is a block diagram illustrating another configuration example of three-dimensional data decoder 213 according to the present embodiment. In this example, three-dimensional data decoder 213 includes vertex information generator 231, attribute information generator 232, video decoder 234, metadata decoder 223, and demultiplexer 224. Vertex information generator 231, attribute information generator 232, and video decoder 234 may correspond to vertex information decoder 201, attribute information decoder 203, and the like illustrated in FIG. 8.

In addition, in this example, three-dimensional data decoder 213 decodes three-dimensional data according to a video-based encoding system. In decoding according to the video-based encoding system, a plurality of two-dimensional images are decoded according to a video encoding system and three-dimensional data is generated from the plurality of two-dimensional images. In this case, the video encoding system may be HEVC (high efficiency video coding), VVC (versatile video coding), or the like.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information, the metadata of the compressed vertex information, the compressed attribute information, and the metadata of the compressed attribute information are input to video decoder 234. The compressed metadata is input to metadata decoder 223.

Video decoder 234 decodes a vertex image according to the video encoding system. In doing so, video decoder 234 decodes the vertex image from the compressed vertex information using the metadata of the compressed vertex information. In addition, video decoder 234 inputs the vertex image into vertex information generator 231. Furthermore, video decoder 234 decodes an attribute image according to the video encoding system. In doing so, video decoder 234 decodes the attribute image from the compressed attribute information using the metadata of the compressed attribute information. In addition, video decoder 234 inputs the attribute image into attribute information generator 232.

Metadata decoder 223 decodes metadata from the compressed metadata. The metadata decoded by metadata decoder 223 includes map information to be used to generate vertex information and to generate attribute information. In addition, the metadata decoded by metadata decoder 223 may be used to decode the vertex image and to decode the attribute image.

Vertex information generator 231 reproduces vertex information from the vertex image according to the map information included in the metadata decoded by metadata decoder 223. Attribute information generator 232 reproduces attribute information from the attribute image according to the map information included in the metadata decoded by metadata decoder 223.

Subsequently, the vertex information, the attribute information, and the metadata are output from three-dimensional data decoder 213 as three-dimensional data. For example, the metadata is metadata of vertex information and attribute information and can be used in an application program.

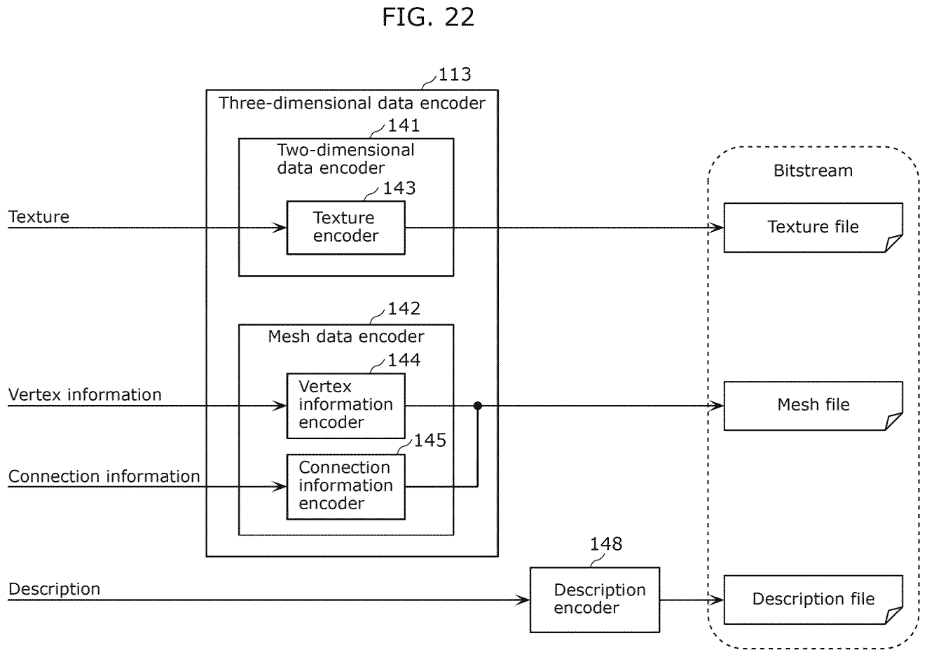

FIG. 22 is a conceptual diagram illustrating a specific example of encoding processing according to the present embodiment. FIG. 22 illustrates three-dimensional data encoder 113 and description encoder 148. In this example, three-dimensional data encoder 113 includes two-dimensional data encoder 141 and mesh data encoder 142. Two-dimensional data encoder 141 includes texture encoder 143. Mesh data encoder 142 includes vertex information encoder 144 and connection information encoder 145.

Vertex information encoder 144, connection information encoder 145, and texture encoder 143 may correspond to vertex information encoder 101, connection information encoder 102, attribute information encoder 103, and the like illustrated in FIG. 6.

For example, two-dimensional data encoder 141 operates as texture encoder 143 and generates a texture file by encoding a texture corresponding to attribute information as two-dimensional data according to an image encoding system or a video encoding system.

In addition, mesh data encoder 142 operates as vertex information encoder 144 and connection information encoder 145 and generates a mesh file by encoding vertex information and connection information. Mesh data encoder 142 may further encode mapping information with respect to a texture. The encoded mapping information may be included in a mesh file.

In addition, description encoder 148 generates a description file by encoding a description corresponding to metadata such as text data. Description encoder 148 may encode a description in the system layer. For example, description encoder 148 may be included in system multiplexer 114 illustrated in FIG. 12.

Due to the operation described above, a bitstream including a texture file, a mesh file, and a description file is generated. The files may be multiplexed in the bitstream in a file format such as glTF (graphics language transmission format) or USD (universal scene description).

Note that three-dimensional data encoder 113 may include two mesh data encoders as mesh data encoder 142. For example, one mesh data encoder encodes vertex information and connection information of a static three-dimensional mesh and the other mesh data encoder encodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

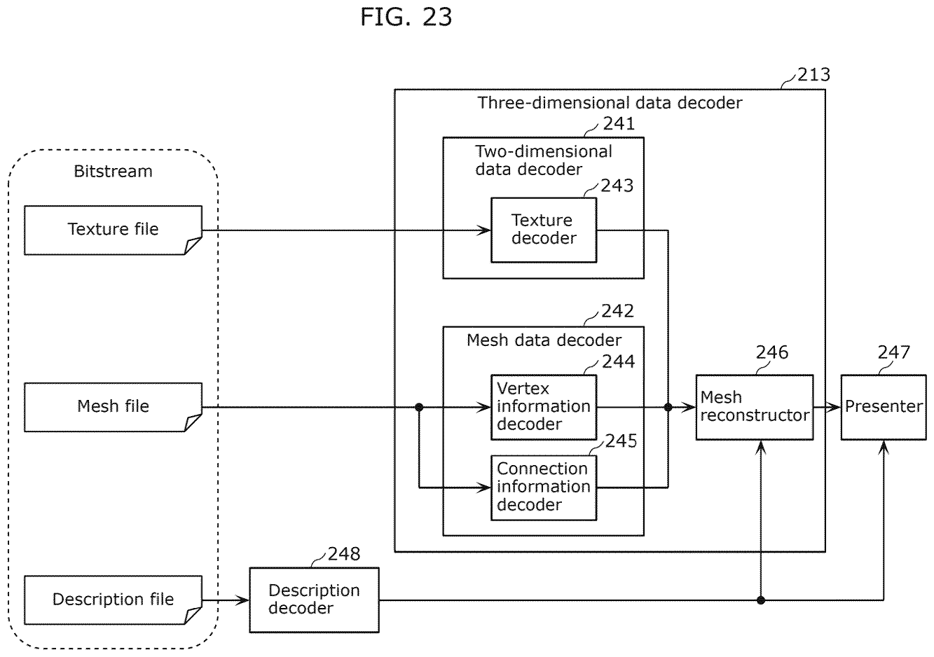

FIG. 23 is a conceptual diagram illustrating a specific example of decoding processing according to the present embodiment. FIG. 23 illustrates three-dimensional data decoder 213, description decoder 248, and presenter 247. In this example, three-dimensional data decoder 213 includes two-dimensional data decoder 241, mesh data decoder 242, and mesh reconstructor 246. Two-dimensional data decoder 241 includes texture decoder 243. Mesh data decoder 242 includes vertex information decoder 244 and connection information decoder 245.

Vertex information decoder 244, connection information decoder 245, texture decoder 243, and mesh reconstructor 246 may correspond to vertex information decoder 201, connection information decoder 202, attribute information decoder 203, postprocessor 205, and the like illustrated in FIG. 8. Presenter 247 may correspond to presenter 215 and the like illustrated in FIG. 12.

For example, two-dimensional data decoder 241 operates as texture decoder 243 and decodes a texture corresponding to attribute information from a texture file as two-dimensional data according to an image encoding system or a video encoding system.

In addition, mesh data decoder 242 operates as vertex information decoder 244 and connection information decoder 245 and decodes vertex information and connection information from a mesh file. Mesh data decoder 242 may further decode mapping information with respect to a texture from the mesh file.

Furthermore, description decoder 248 decodes a description corresponding to metadata such as text data from a description file. Description decoder 248 may decode a description in the system layer. For example, description decoder 248 may be included in system demultiplexer 214 illustrated in FIG. 12.

Mesh reconstructor 246 reconstructs a three-dimensional mesh from vertex information, connection information, and a texture according to a description. Presenter 247 renders and outputs the three-dimensional mesh according to the description.

Due to the operation described above, a three-dimensional mesh is reconstructed and output from a bitstream including a texture file, a mesh file, and a description file.

Note that three-dimensional data decoder 213 may include two mesh data decoders as mesh data decoder 242. For example, one mesh data decoder decodes vertex information and connection information of a static three-dimensional mesh and the other mesh data decoder decodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

An encoding system of a dynamic three-dimensional mesh may be called DMC (dynamic mesh coding). In addition, a video-based encoding system of a dynamic three-dimensional mesh may be called VDMC (video-based dynamic mesh coding).

An encoding system of a point cloud may be called PCC (point cloud compression). A video-based encoding system of a point cloud may be called V-PCC (video-based point cloud compression). In addition, a geometry-based encoding system of a point cloud may be called G-PCC (geometry-based point cloud compression).

### Implementation Example

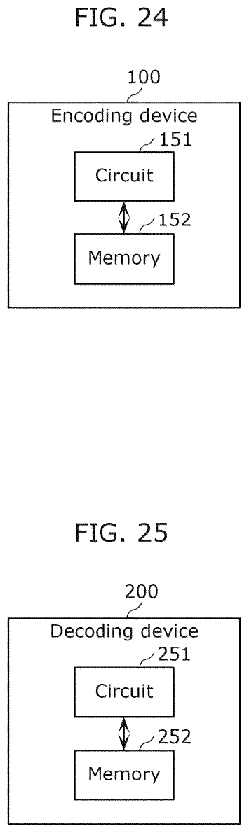

FIG. 24 is a block diagram illustrating an implementation example of encoding device 100 according to the present embodiment. Encoding device 100 includes circuit 151 and memory 152. For example, a plurality of constituent elements of encoding device 100 illustrated in FIG. 5 and the like are implemented by circuit 151 and memory 152 illustrated in FIG. 24.

Circuit 151 is a circuit which performs information processing and which is capable of accessing memory 152. For example, circuit 151 is a dedicated or general-purpose electric circuit which encodes a three-dimensional mesh. Circuit 151 may be a processor such as a CPU. Alternatively, circuit 151 may be a set of a plurality of electric circuits.

Memory 152 is a dedicated or general-purpose memory that stores information used by circuit 151 to encode a three-dimensional mesh. Memory 152 may be an electric circuit and may be connected to circuit 151. In addition, memory 152 may be included in circuit 151. Alternatively, memory 152 may be a set of a plurality of electric circuits. Furthermore, memory 152 may be a magnetic disk, an optical disk, or the like or may be expressed as a storage, a recording medium, or the like. In addition, memory 152 may be a non-volatile memory or a volatile memory.

For example, memory 152 may store a three-dimensional mesh or a bitstream. In addition, memory 152 may store a program used by circuit 151 to encode a three-dimensional mesh.

Note that in encoding device 100, all of the plurality of constituent elements illustrated in FIG. 5 and the like need not be implemented and all of the plurality of processing steps described herein need not be performed. A part of the plurality of constituent elements illustrated in FIG. 5 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in encoding device 100.

FIG. 25 is a block diagram illustrating an implementation example of decoding device 200 according to the present embodiment. Decoding device 200 includes circuit 251 and memory 252. For example, a plurality of constituent elements of decoding device 200 illustrated in FIG. 7 and the like are implemented by circuit 251 and memory 252 illustrated in FIG. 25.

Circuit 251 is a circuit which performs information processing and which is capable of accessing memory 252. For example, circuit 251 is a dedicated or general-purpose electric circuit which decodes a three-dimensional mesh. Circuit 251 may be a processor such as a CPU. Alternatively, circuit 251 may be a set of a plurality of electric circuits.

Memory 252 is a dedicated or general-purpose memory that stores information used by circuit 251 to decode a three-dimensional mesh. Memory 252 may be an electric circuit and may be connected to circuit 251. In addition, memory 252 may be included in circuit 251. Alternatively, memory 252 may be a set of a plurality of electric circuits. Furthermore, memory 252 may be a magnetic disk, an optical disk, or the like or may be expressed as a storage, a recording medium, or the like. In addition, memory 252 may be a non-volatile memory or a volatile memory.

For example, memory 252 may store a three-dimensional mesh or a bitstream. In addition, memory 252 may store a program used by circuit 251 to decode a three-dimensional mesh.

Note that in decoding device 200, all of the plurality of constituent elements illustrated in FIG. 7 and the like need not be implemented and all of the plurality of processing steps described herein need not be performed. A part of the plurality of constituent elements illustrated in FIG. 7 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in decoding device 200.

An encoding method and a decoding method including steps performed by each constituent element of encoding device 100 and decoding device 200 according to the present disclosure may be executed by any device or system. For example, a part of or all of the encoding method and the decoding method may be executed by a computer including a processor, a memory, an input/output circuit, and the like. In doing so, the encoding method and the decoding method may be executed by having the computer execute a program that enables the computer to execute the encoding method and the decoding method.

In addition, a program or a bitstream may be recorded on a non-transitory computer-readable recording medium such as a CD-ROM.

An example of a program may be a bitstream. For example, a bitstream including an encoded three-dimensional mesh includes a syntax element that enables decoding device 200 to decode the three-dimensional mesh. In addition, the bitstream causes decoding device 200 to decode the three-dimensional mesh according to the syntax element included in the bitstream. Therefore, a bitstream can perform a similar role to a program.

The bitstream described above may be an encoded bitstream including an encoded three-dimensional mesh or a multiplexed bitstream including an encoded three-dimensional mesh and other information.

In addition, each constituent element of encoding device 100 and decoding device 200 may be constituted of dedicated hardware, general-purpose hardware which executes the program or the like described above, or a combination thereof. Furthermore, the general-purpose hardware may be constituted of a memory on which a program is recorded, a general-purpose processor which reads the program from the memory and executes the program, and the like. In this case, the memory may be a semiconductor memory, a hard disk, or the like and the general-purpose processor may be a CPU or the like.

Furthermore, the dedicated hardware may be constituted of a memory, a dedicated processor, and the like. For example, the dedicated processor may execute the encoding method and the decoding method by referring to a memory for recording data.

In addition, as described above, the respective constituent elements of encoding device 100 and decoding device 200 may be electric circuits. The electric circuits may constitute one electric circuit as a whole or may be respectively different electric circuits. Furthermore, the electric circuits may correspond to dedicated hardware or to general-purpose hardware which executes the program or the like described above. Moreover, encoding device 100 and decoding device 200 may be implemented as integrated circuits.

In addition, encoding device 100 may be a transmitting device which transmits a three-dimensional mesh. Decoding device 200 may be a receiving device which receives a three-dimensional mesh.

### Encoding Process and Decoding Process

A generic three-dimensional model represents an object digitally such that a user can explore the three-dimensional model by using zooming, panning, and/or rotation in all three dimensions while rendering it temporally. One way to construct such representation is to construct a three-dimensional mesh. The three-dimensional mesh uses faces that are formed by connecting vertices via edges to represent a surface of the object. The majority of three-dimensional meshes uses triangular faces. For example, one of a plurality of faces forming a three-dimensional mesh contains three vertices. Additionally, the three-dimensional mesh may be parametrized to generate a two-dimensional UV map. This is used to project attributes represented in the two-dimensional format onto the surface of the three-dimensional mesh. For example, a renderer can project texture information stored in a two-dimensional image onto a three-dimensional mesh using the three-dimensional mesh's associated UV map. Storing all this information in the uncompressed form needs an extremely large storage space. Thus, transmission of such information requires an extremely high bandwidth. The triangles forming the three-dimensional mesh often have repetitive patterns and similar attributes, especially in the temporal and spatial neighborhood. These repetitions can be used to formulate an efficient encoding method and decoding method for storage and transmission. One such encoding method and decoding method is Video-based Dynamic Mesh Coding (V-DMC).

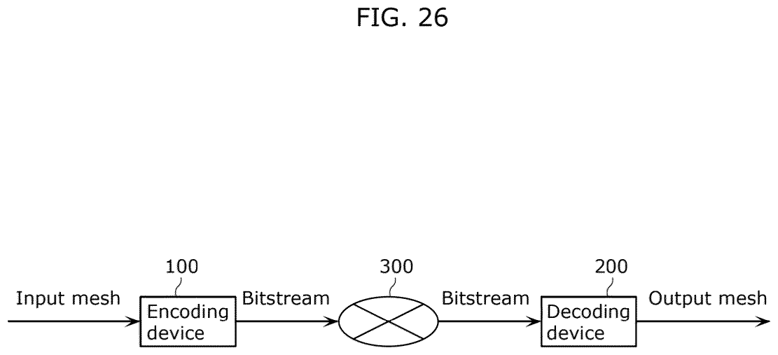

FIG. 26 is a block diagram illustrating a configuration example of an encoding and decoding system according to the present embodiment.

Encoding device 100 takes in an input mesh (a three-dimensional mesh frame inputted to encoding device 100) in the form of three-dimensional coordinates of vertices (vertex coordinates), connection information, and associated attributes. Encoding device 100 is responsible for encoding all the relevant information into a bitstream.

Network 300 transmits the bitstream generated by encoding device 100 to decoding device 200. Network 300 may be the Internet, the Wide Area Network (WAN), the Local Area Network (LAN), or any combination of these networks. Network 300 is not necessarily limited to a bi-directional communication network, and may be a uni-directional communication network which transmits broadcast waves of digital terrestrial broadcasting, satellite broadcasting, or the like. Alternatively, network 300 may be replaced by a recording medium such as a Digital Versatile Disc (DVD) and a Blu-Ray Disc (BD), etc. on which a bitstream is recorded. The bitstream is transmitted to decoding device 200 through network 300.

Decoding device 200 decodes the bitstream to generate a three-dimensional mesh frame (an output mesh) using decoded three-dimensional coordinates of vertices, decoded connectivity, and decoded associated attributes.

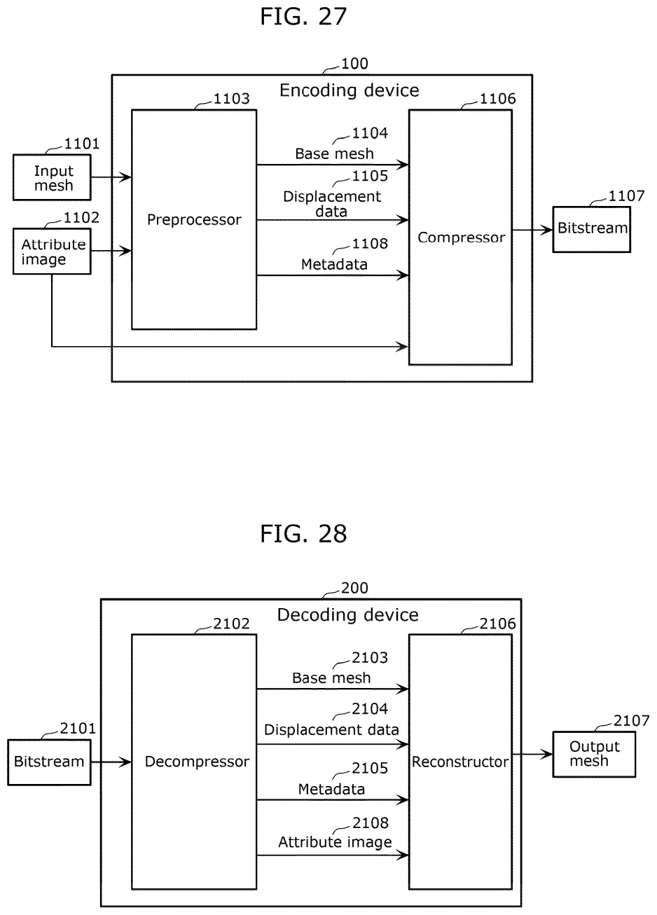

FIG. 27 is a block diagram illustrating another configuration example of encoding device 100 according to the present embodiment.

As illustrated in FIG. 27, encoding device 100 includes preprocessor 1103 and compressor 1106.

Encoding device 100 reads input mesh 1101 and attribute image 1102 and outputs them to preprocessor 1103.

Preprocessor 1103 extracts base mesh 1104 and displacement data 1105 by processing input mesh 1101. An example of attribute image 1102 is a texture (texture data) represented by an image (a texture image). Along with extracted base mesh 1104 and displacement data 1105, attribute image 1102 is outputted to compressor 1106.

Compressor 1106 compresses base mesh 1104, displacement data 1105, and attribute image 1102 to generate bitstream 1107. By additionally including metadata 1108 into bitstream 1107, compressor 1106 can transmit supplementary information to decoding device 200.

FIG. 28 is a block diagram illustrating another configuration example of decoding device 200 according to the present embodiment.

As illustrated in FIG. 28, decoding device 200 includes decompressor 2102 and reconstructor 2106.

Decoding device 200 reads bitstream 2101 and outputs it to decompressor 2102.

Decompressor 2102 decompresses base mesh 2103, displacement data 2104, and attribute image 2108 from bitstream 2101 and outputs them to reconstructor 2106. An example of attribute image 2108 is texture data represented by an image. An example of displacement data 2104 is a displacement vector.

Reconstructor 2106 generates output mesh 2107 by processing base mesh 2103 according to displacement data 2104 and attribute image 2108. Reconstructor 2106 may generate output mesh 2107 by additionally using information from metadata 2105.

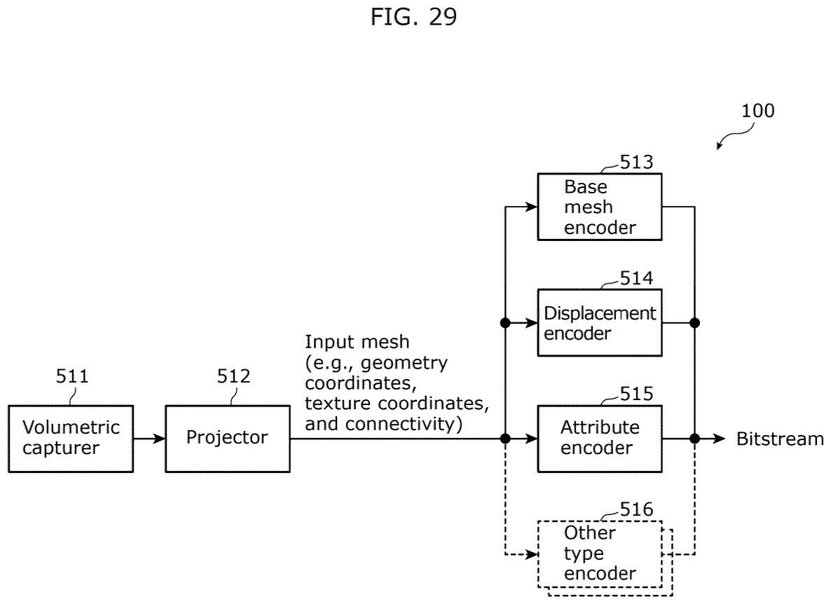

FIG. 29 is a block diagram illustrating yet another configuration example of encoding device 100 according to the present embodiment.

In the present example, encoding device 100 includes volumetric capturer 511, projector 512, base mesh encoder 513, displacement encoder 514, attribute encoder 515, and optionally one or more other type encoders 516.

Volumetric capturer 511 captures content and outputs the captured content to projector 512.

Projector 512 projects the content onto an input mesh (a three-dimensional mesh frame) that includes, for example, geometry coordinates (vertex coordinates indicating the positions of vertices), texture coordinates, and connectivity (connection information). The data are outputted to base mesh encoder 513, displacement encoder 514, attribute encoder 515, and optionally one or more other type encoders 516. Each encoder compresses the data into a bitstream.

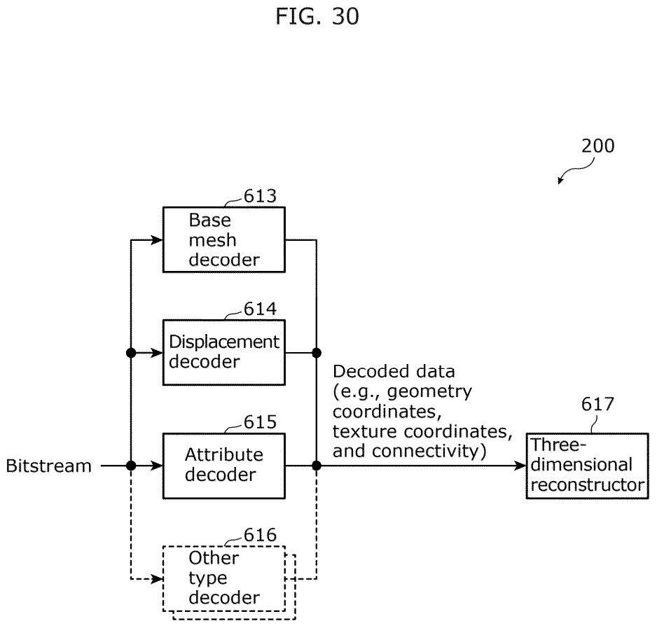

FIG. 30 is a block diagram illustrating yet another configuration example of decoding device 200 according to the present embodiment.

In the present example, decoding device 200 includes base mesh decoder 613, displacement decoder 614, attribute decoder 615, one or more other type decoders 616, and three-dimensional reconstructor 617.

A bitstream is sent to base mesh decoder 613, displacement decoder 614, attribute decoder 615, and optionally one or more other type decoders 616. By decoding the bitstream, these decoders generate data (decoded data) that includes, for example, geometry coordinates, texture coordinates, and connectivity. The decoded data is then sent to three-dimensional reconstructor 617 to reconstruct an output mesh (a three-dimensional mesh frame).

Hereinafter, an encoding process performed by encoding device 100 will be described in detail.

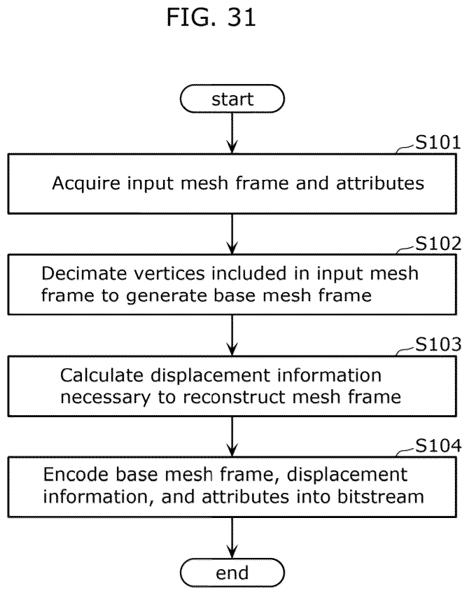

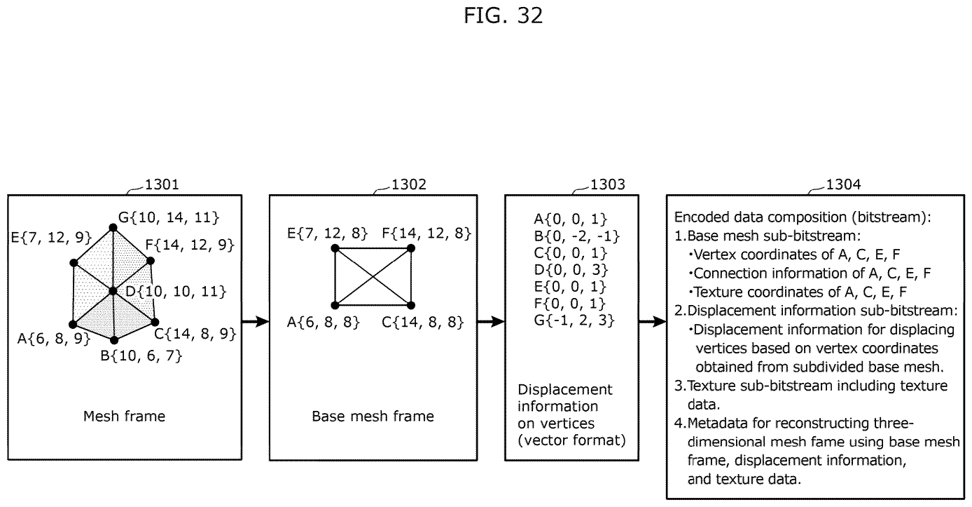

FIG. 31 is a flowchart illustrating the process performed by encoding device 100. FIG. 32 is an explanatory diagram schematically illustrating the encoding of a mesh frame. With reference to FIG. 31 and FIG. 32, the process performed by encoding device 100 will be described.

In step S101, encoding device 100 reads a three-dimensional mesh frame, which is an input mesh frame, and its attributes. The input mesh frame is a mesh frame inputted into encoding device 100. An example of the three-dimensional mesh frame, which is the input mesh frame, is illustrated as mesh frame 1301 (see FIG. 32).

In step S102, encoding device 100 performs the decimating process on the input mesh frame that is read in step S101 to generate a base mesh frame, which has a smaller number of vertices than the input mesh frame. The base mesh frame generated by decimating mesh frame 1301 is illustrated as base mesh frame 1302 (see FIG. 32).

In step S103, encoding device 100 calculates displacement information to be used by decoding device 200 to reconstruct the mesh frame. The displacement information is equivalent to displacement vectors from the vertices of the base mesh frame generated in step S102 to the vertices of the input mesh frame. Methods of calculating the displacement information include a method in which the sets of coordinates of the vertices of the base mesh frame are subtracted from the coordinates of the vertices of the input mesh frame. The displacement information calculated from mesh frame 1301 and base mesh frame 1302 is illustrated as displacement information 1303 (see FIG. 32). Displacement information 1303 is in a vector format. In other words, displacement information 1303 is represented as displacement vectors.

In step S104, encoding device 100 encodes the base mesh frame generated in step S102, the displacement information generated in step S103, and the attributes of the input mesh frame into a bitstream (equivalent to a compressed bitstream). An example of the bitstream is illustrated as bitstream 1304 (see FIG. 32).

As illustrated in FIG. 32, for example, bitstream 1304 includes: a bitstream including the base mesh frame (a base mesh sub-bitstream); a bitstream including displacement information (a displacement information sub-bitstream); a bitstream including texture data (a texture sub-bitstream); and metadata.

The base mesh sub-bitstream includes information indicating, for example, vertex coordinates and connectivity (connection information) of vertices A, C, E, and F.

The displacement information sub-bitstream includes displacement information indicating displacement coordinates for displacing the vertices based on the vertex coordinates obtained from the subdivided base mesh frame.

The metadata is data that allows decoding device 200 to reconstruct a three-dimensional mesh frame by using the base mesh frame, the displacement information, and the texture data.

First, encoding device 100 decimates mesh frame 1301 to acquire base mesh frame 1302 containing fewer vertices than mesh frame 1301. After decimation, there is a possibility that the vertices are not in the original positions and that the vertex connectivity changes.

Next, encoding device 100 performs texture parametrization on base mesh frame 1302 to generate texture coordinates (two-dimensional texture coordinates) also known as a UV map.

Subsequently, encoding device 100 subdivides base mesh frame 1302 by adding new vertices between the existing connected vertices of base mesh frame 1302.

Next, encoding device 100 calculates displacement information 1303 using the subdivided mesh frame and mesh frame 1301 to move (displace) the vertices generated by the subdivision. In an example, the vertices generated by the subdivision are moved to positions similar to mesh frame 1301. Displacement information 1303 is transformed by wavelet transformation into wavelet coefficients and encoded using a video codec by mapping the coefficients onto planes of a video frame. The texture data in mesh frame 1301 and the metadata are also encoded and included into bitstream 1304.

Hereinafter, a decoding process performed by decoding device 200 will be described in detail.

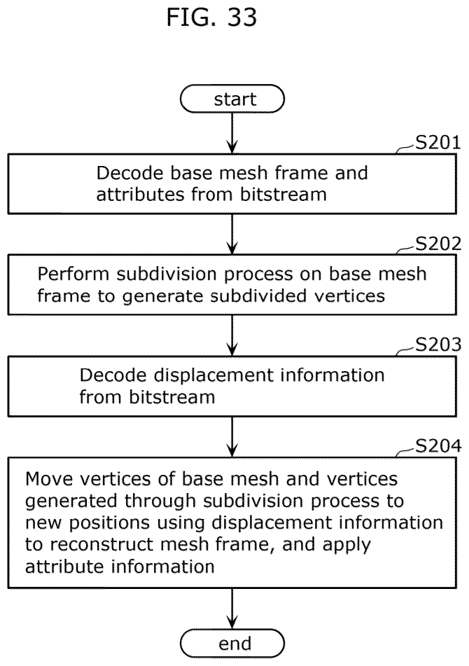

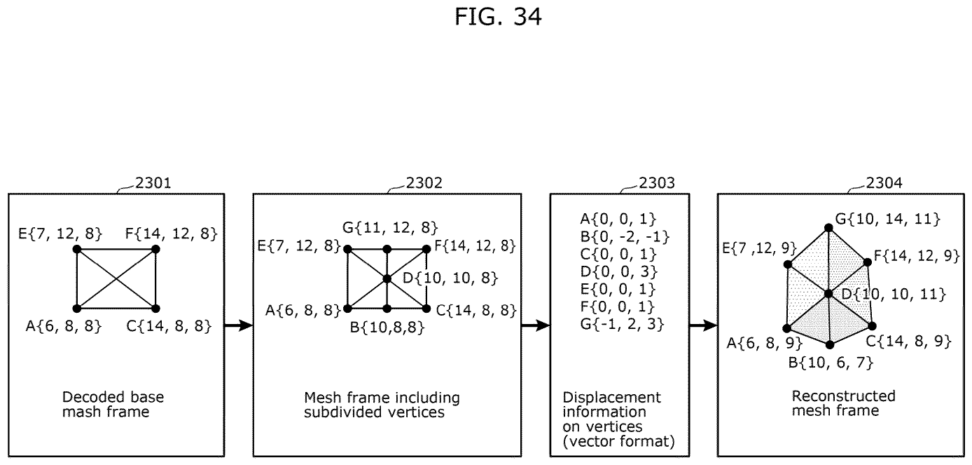

FIG. 33 is a flowchart illustrating the process performed by decoding device 200. FIG. 34 is an explanatory diagram schematically illustrating the decoding of a mesh frame. With reference to FIG. 33 and FIG. 34, the process performed by decoding device 200 will be described.

In step S201, decoding device 200 decodes a base mesh frame and attributes from a bitstream (equivalent to a compressed bitstream). An example of the decoded base mesh frame (equivalent to a decoded base mesh frame) is illustrated as decoded base mesh frame 2301 (see FIG. 34).

In step S202, decoding device 200 performs the subdivision process on the base mesh frame decoded in step S201 to generate subdivided vertices. An example of the mesh frame (base mesh frame) including the subdivided vertices is illustrated as mesh frame 2302 (see FIG. 34).

In step S203, decoding device 200 decodes displacement information from the bitstream (equivalent to the compressed bitstream). An example of the decoded displacement information is illustrated as displacement information 2303 (see FIG. 34). Displacement information 2303 is in a vector format. In other words, displacement information 2303 is represented as displacement vectors.

In step S204, using the displacement information, decoding device 200 moves the vertices of the base mesh frame including the subdivided vertices to new positions to reconstruct the shape of the mesh frame and further applies attribute information to restore the mesh frame. An example of the attributes is a texture. An example of the reconstructed mesh frame is illustrated as mesh frame 2304 (see FIG. 34).

As illustrated in FIG. 34, first, decoding device 200 decodes base mesh frame 2301. Base mesh frame 2301 decoded may include texture coordinates for the vertices of base mesh frame 2301. Alternatively, high-level syntax parameters may be used by decoding device 200 to apply parametrization of texture (texture parametrization) to base mesh frame 2301. By subdividing base mesh frame 2301 multiple times, decoding device 200 may generate (create) mesh frame 2302 including vertices subdivided through addition of new vertices between the already connected vertices.

After this processing, all the vertices and connectivity are obtained. The wavelet coefficients are decoded by decoding device 200, and inverse wavelet transformation is applied to reconstruct displacement information 2303. Displacement information 2303 is used to move the vertices of mesh frame 2302 subdivided. The texture is mapped on the faces created by the vertices and their connectivity. Accordingly, a fully decoded mesh (reconstructed mesh frame 2304) is obtained.

The texture coordinates of the base mesh frame may be generated by encoding device 100 and signaled in the base mesh sub-bitstream to decoding device 200. Alternatively, a set of high-level syntax parameters may be included in the compressed bitstream which is used by decoding device 200 to derive a UV map of the base mesh frame.

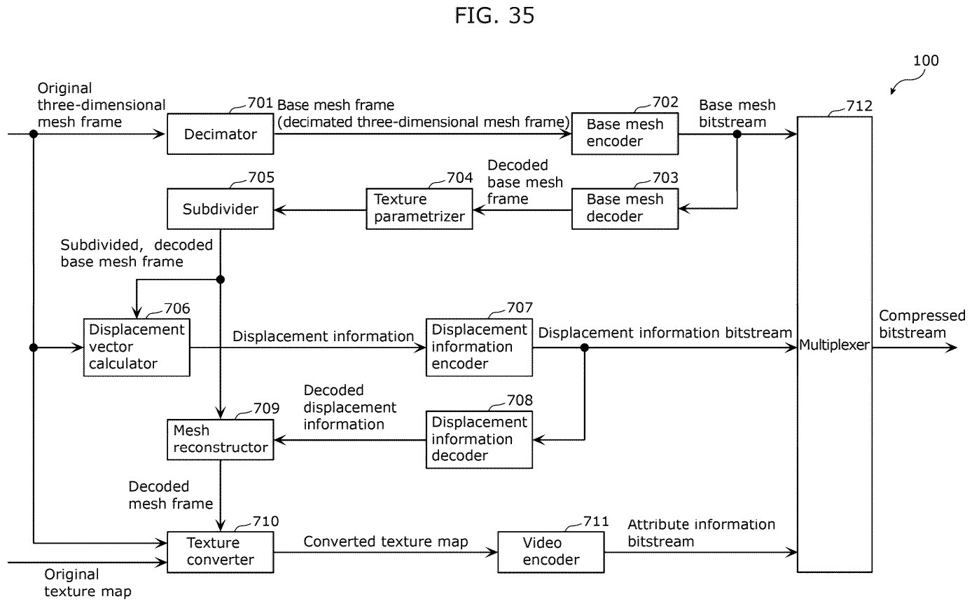

FIG. 35 is a block diagram illustrating yet another configuration example of encoding device 100 according to the embodiment. In the present example, encoding device 100 includes decimator 701, base mesh encoder 702, base mesh decoder 703, texture parametrizer 704, subdivider 705, displacement vector calculator 706, displacement information encoder 707, displacement information decoder 708, mesh reconstructor 709, texture converter 710, video encoder 711, and multiplexer 712.

Encoding device 100 receives inputs of an original three-dimensional mesh frame and an original texture map. The original three-dimensional mesh frame is inputted to decimator 701, displacement vector calculator 706, and texture converter 710. The original texture map is inputted to texture converter 710.

Decimator 701 decimates the original three-dimensional mesh frame to generate a base mesh frame, and outputs the generated base mesh frame to base mesh encoder 702.

Base mesh encoder 702 encodes the base mesh frame. For example, base mesh encoder 702 outputs a base mesh bitstream (for example, the base mesh sub-bitstream described above) including the encoded base mesh frame to multiplexer 712 and base mesh decoder 703.

Base mesh decoder 703 decodes the base mesh frame from the base mesh bitstream and outputs the decoded base mesh frame to texture parametrizer 704.

Texture parametrizer 704 calculates texture coordinates based on the decoded base mesh frame, and outputs the calculated texture coordinates and the decoded base mesh frame to subdivider 705. Specifically, texture parametrizer 704 develops the restored base mesh frame on a two-dimensional plane, and calculates, as texture coordinates (UV coordinates), two-dimensional coordinates corresponding to the vertices of each face (for example, each triangle included in the three-dimensional mesh frame) of the base mesh frame.

Subdivider 705 subdivides the decoded base mesh frame, and outputs the subdivided, decoded base mesh frame to displacement vector calculator 706 and mesh reconstructor 709. Subdivider 705 also outputs the calculated texture coordinates to mesh reconstructor 709. Specifically, subdivider 705 fractionalizes the faces of the restored base mesh frame by subdivision.

Displacement vector calculator 706 calculates displacement vectors based on the original three-dimensional mesh frame and the subdivided, decoded base mesh frame, and outputs the calculated displacement vectors as displacement information to displacement information encoder 707. Specifically, displacement vector calculator 706 derives, according to the original three-dimensional mesh frame received, the displacement vectors of the vertices of the subdivided, restored base mesh frame.

Displacement information encoder 707 encodes displacement information. For example, displacement information encoder 707 outputs a displacement information bitstream (for example, the displacement information sub-bitstream described above) including the encoded displacement information to multiplexer 712 and displacement information decoder 708.

Displacement information decoder 708 decodes the displacement information from the displacement information bitstream, and outputs the decoded displacement information to mesh reconstructor 709.

Mesh reconstructor 709 decodes (reconstructs) the mesh frame, based on the subdivided, decoded base mesh frame and the decoded displacement information. Specifically, mesh reconstructor 709 decodes the mesh frame by displacing each vertex of the subdivided, decoded base mesh frame, based on the displacement information. Mesh reconstructor 709 outputs the mesh frame decoded in the above-described manner and the calculated texture coordinates to texture converter 710.

Texture converter 710 converts the original texture map, based on the decoded mesh frame, the calculated texture coordinates, and the original three-dimensional mesh frame, and outputs the converted texture map to video encoder 711. Specifically, texture converter 710 converts the received original texture map according to the two-dimensional coordinates corresponding to the vertices of each face of the restored base mesh frame.

Video encoder 711 encodes the converted texture map. For example, video encoder 711 outputs an attribute information bitstream (for example, the texture sub-bitstream described above) including, as an attribute (attribute information), the encoded, converted texture map to multiplexer 712.

Multiplexer 712 generates and outputs a compressed bitstream including: the base mesh bitstream; the displacement information bitstream; and the attribute information bitstream.

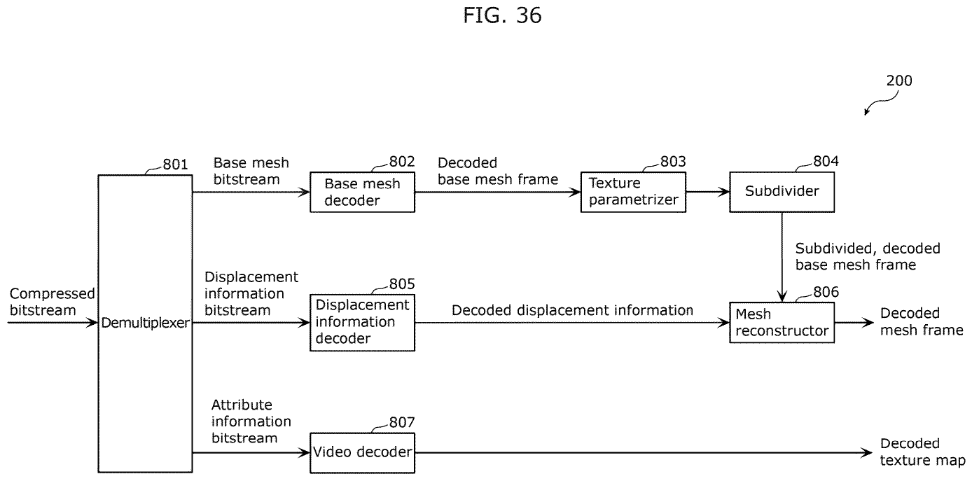

FIG. 36 is a block diagram illustrating yet another configuration example of decoding device 200 according to the embodiment. In the present example, decoding device 200 includes demultiplexer 801, base mesh decoder 802, texture parametrizer 803, subdivider 804, displacement information decoder 805, mesh reconstructor 806, and video decoder 807.

Decoding device 200 receives an input of a compressed bitstream. The compressed bitstream is inputted to demultiplexer 801.

Demultiplexer 801 separates the compressed bitstream into a base mesh bitstream, a displacement information bitstream, and an attribute information bitstream. Demultiplexer 801 outputs the base mesh bitstream to base mesh decoder 802, outputs the displacement information bitstream to displacement information decoder 805, and outputs the attribute information bitstream to video decoder 807.

Base mesh decoder 802 decodes the base mesh frame from the base mesh bitstream and outputs the decoded base mesh frame to texture parametrizer 803.

Texture parametrizer 803 calculates texture coordinates, based on the decoded base mesh frame, and outputs the calculated texture coordinates and the decoded base mesh frame to subdivider 804.

Subdivider 804 subdivides the decoded base mesh frame, and outputs the subdivided, decoded base mesh frame and the calculated texture coordinates to mesh reconstructor 806.

Displacement information decoder 805 decodes the displacement information from the displacement information bitstream, and outputs the decoded displacement information to mesh reconstructor 806.

Mesh reconstructor 806 decodes (reconstructs) the mesh frame, based on the decoded displacement information and the subdivided, decoded base mesh frame. Specifically, mesh reconstructor 806 decodes the mesh frame by displacing each vertex of the subdivided, decoded base mesh frame, based on the displacement information. Mesh reconstructor 806 outputs the mesh frame decoded in the above-described manner and the calculated texture coordinates.

Video decoder 807 decodes the texture map from the attribute information bitstream, and outputs the decoded texture map.

A textured mesh frame is reconstructed based on the decoded mesh frame, the calculated texture coordinates, and the decoded texture map that have been outputted in the above-described manner.

Note that an intra coding process or an inter coding process may be performed on the base mesh frame, based on a parameter in the bitstream. For example, an edge-breaker algorithm may be used for decoding the base mesh frame.

The displacement information may be included in a bitstream in an image format having two chroma information items and one luma information item, and may be decoded using a video frame decompression method. The displacement information may be decoded using arithmetic decoding. Decoding device 200, for example, may extract the wavelet coefficients related to each vertex from decompressed data in an image format, perform inverse quantization on quantized wavelet coefficients in the three components related to each vertex, and perform inverse transform on the result to obtain the final decoded displacement information.

The decoded texture map (attribute image) may be further processed for conversion of the color space and the color format.

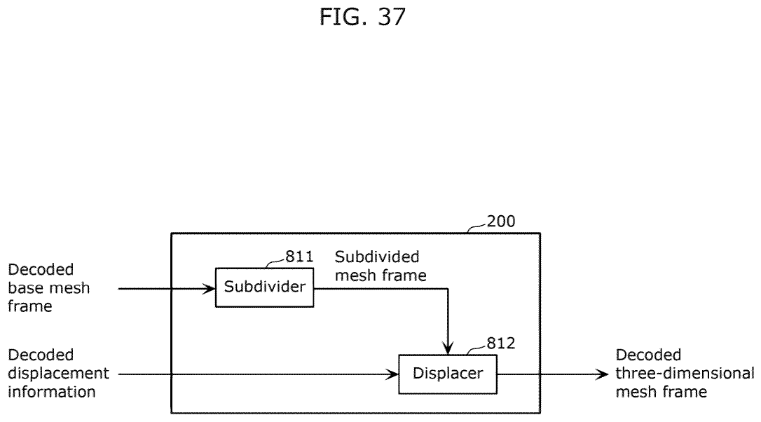

FIG. 37 is a block diagram illustrating a detailed configuration example of decoding device 200 according to the embodiment. Specifically, FIG. 37 is a diagram illustrating an example of a reconstructor that performs subdivision and displacement processing to obtain a decoded mesh frame from the decoded base mesh frame and the decoded displacement information. Decoding device 200 includes subdivider 811 and displacer 812.

The decoded base mesh frame is outputted to subdivider 811.

Subdivider 811 performs subdivision by adding a new vertex between any two connected vertices of the entire mesh frame. This process is repeated several times to include the vertices created in the previous subdivision process, to generate a predefined number of vertices. Each subdivision iteration over the entire three-dimensional mesh frame generates a new level of detail (LoD). The subdivided mesh frame and the decoded displacement information are outputted to displacer 812.

Displacer 812 moves (displaces) each vertex to a new position according to the corresponding displacement information to generate a final decoded three-dimensional mesh frame.

Hereinafter, the subdivision will be described.

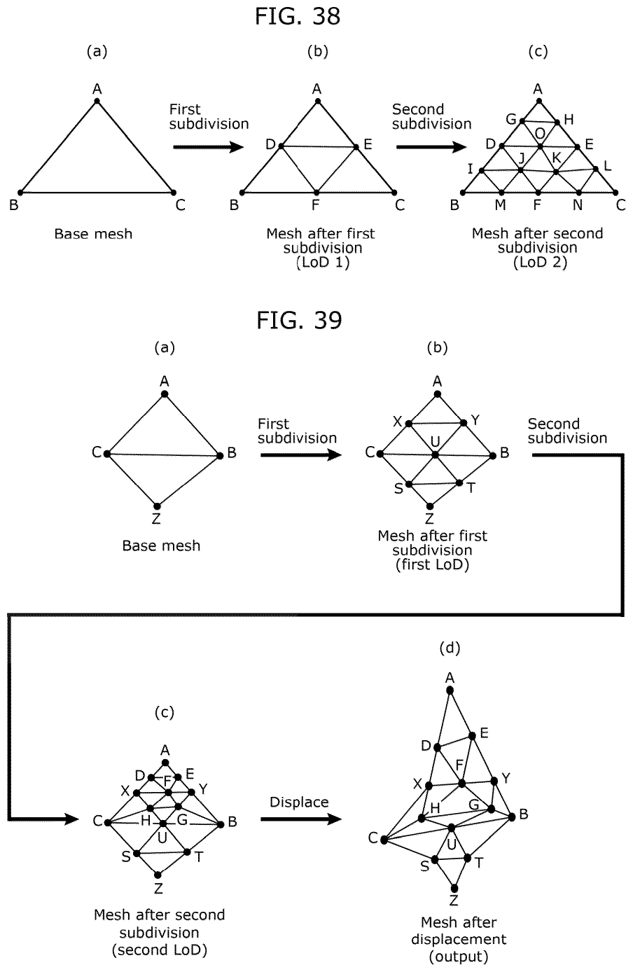

FIG. 38 is an explanatory diagram illustrating an example of the subdivision.

A base mesh illustrated in (a) in FIG. 38 includes vertices A, B, and C and connection information indicating their connectivity.

In (b) in FIG. 38, a mesh produced by the first subdivision, in other words, a mesh after the first subdivision is illustrated. In the first subdivision, the subdivider generates vertices D, E, and F and connection information indicating their connectivity. This mesh produced by the subdivider will also be referred to as LoD1 or a first LoD.

Vertex D in the mesh after the first subdivision is a vertex that is generated by subdivision based on vertex A and vertex B. Likewise, vertex F is a vertex that is generated by subdivision based on vertex B and vertex C. Vertex E is a vertex that is generated by subdivision based on vertex A and vertex C.

Note that, as an example, vertex D can be the midpoint of segment AB (in other words, edge AB) connecting vertices A and B, which are used to generate vertex D. Likewise, vertex E can be the midpoint of segment AC. Vertex F can be the midpoint of segment BC.

In (c) in FIG. 38, a mesh produced by the second subdivision, in other words, a mesh after the second subdivision is illustrated. In the second subdivision, the subdivider generates vertices G, H, I, J, K, L, M, N, and O and connection information indicating their connectivity. This mesh produced by the subdivider will also be referred to as LoD2 or a second LoD.

Vertex G in the mesh after the second subdivision is a vertex that is generated by subdivision based on vertex A and vertex D. Likewise, vertex H is a vertex that is generated by subdivision based on vertex A and vertex E. Vertex I is a vertex that is generated by subdivision based on vertex B and vertex D. Vertex J is a vertex that is generated by subdivision based on vertex D and vertex F. Vertex K is a vertex that is generated by subdivision based on vertex E and vertex F. Vertex L is a vertex that is generated by subdivision based on vertex C and vertex E. Vertex M is a vertex that is generated by subdivision based on vertex B and vertex F. Vertex N is a vertex that is generated by subdivision based on vertex C and vertex F. Vertex O is a vertex that is generated by subdivision based on vertex D and vertex E.

Note that, as an example, vertex G can be the midpoint of segment AD (in other words, edge AD) connecting vertices A and D, which are used to generate vertex G. Likewise, vertex H can be the midpoint of segment AE. Vertex I can be the midpoint of segment BD. Vertex J can be the midpoint of segment DF. Vertex K can be the midpoint of segment EF. Vertex L can be the midpoint of segment CE. Vertex M can be the midpoint of segment BF. Vertex N can be the midpoint of segment CF. Vertex O can be the midpoint of segment DE.

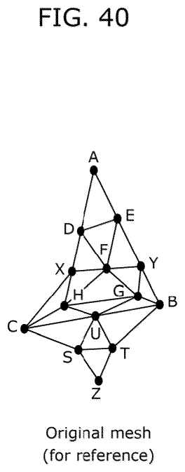

Hereinafter, the displacement of vertices will be described with reference to FIG. 39 and FIG. 40.

FIG. 39 is an explanatory diagram illustrating an example of the displacement of vertices in which the vertices are subdivided and then displaced. FIG. 40 is an explanatory diagram illustrating an example of the vertices of the original mesh.

A base mesh illustrated in (a) in FIG. 39 includes vertices A, B, C, and Z and connection information indicating their connectivity.

In (b) in FIG. 39, a mesh produced by the first subdivision, in other words, a mesh after the first subdivision (i.e., a first LoD) is illustrated. In the first subdivision, the subdivider generates vertex S, T, U, X, or Y and connection information indicating their connectivity. Vertex S, T, U, X, or Y is similar to vertices D, E, and F illustrated in (b) in FIG. 38.

In (c) in FIG. 39, a mesh produced by the second subdivision, in other words, a mesh after the second subdivision (i.e., a second LoD) is illustrated. In the second subdivision, the subdivider generates vertices D, E, F, G, and H and connection information indicating their connectivity. Vertices D, E, F, G, and H are similar to vertices G, H, I, J, K, L, M, N, or O illustrated in (c) in FIG. 38.

In (d) in FIG. 39, a mesh including vertices that are subdivided and then displaced is illustrated. Vertices A, B, C, D, E, F, G, H, S, T, U, X, Y, and Z illustrated in (d) in FIG. 39 are at positions that are displaced from positions of the respective vertices illustrated in (c) in FIG. 39 using the displacement information.

The original mesh illustrated in FIG. 40 is an example of the mesh input into encoding device 100, that is, a mesh before encoding.

The mesh illustrated in FIG. 39 has a shape similar to that of the original mesh illustrated in FIG. 40. Since the displacement information is generated by displacement vector calculator 1207 of encoding device 100 as information indicating the displacement from the vertices of the base mesh to the vertices of the original mesh, the mesh having the shape similar to that of the original mesh is generated by the reconstruction of the mesh using the displacement information that has been generated in such a manner.

Decoding device 200 is capable of outputting the mesh illustrated in (d) in FIG. 39.

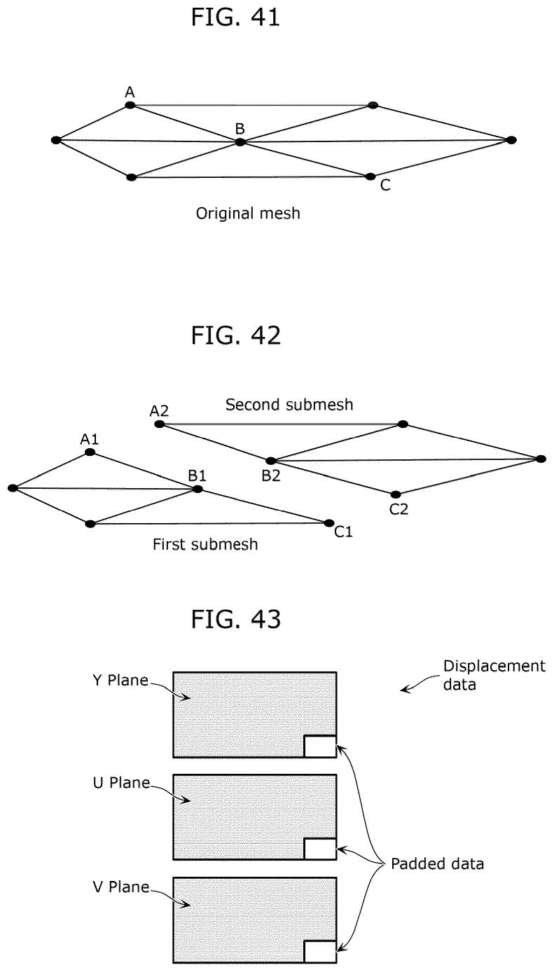

Next, the division of a mesh into submeshes will be described with reference to FIG. 41 and FIG. 42.

The mesh can be divided into a plurality of portions each of which is smaller than the mesh and can be encoded. When the mesh is divided, the vertices of the mesh can be divided such that sets of coordinates and connectivity of the vertices included in each portion are independently encodable.

FIG. 41 is an explanatory diagram illustrating an example of a mesh. FIG. 42 is an explanatory diagram illustrating an example of the division of a mesh into submeshes.

The mesh illustrated in FIG. 41 is an original mesh and may also be referred to as a full mesh, in contrast to a submesh.

FIG. 42 illustrates how the full mesh illustrated in FIG. 41 is divided into two submeshes. For vertices A, B, and C of the full mesh (see FIG. 41), vertex A is duplicated into vertex A1 and vertex A2, vertex B is duplicated into vertex B1 and vertex B2, and vertex C is duplicated into vertex C1 and vertex C2. Thus, the two submeshes (i.e., a first submesh and a second submesh) are generated from the full mesh. The first submesh and the second submesh are meshes that are independently decodable.

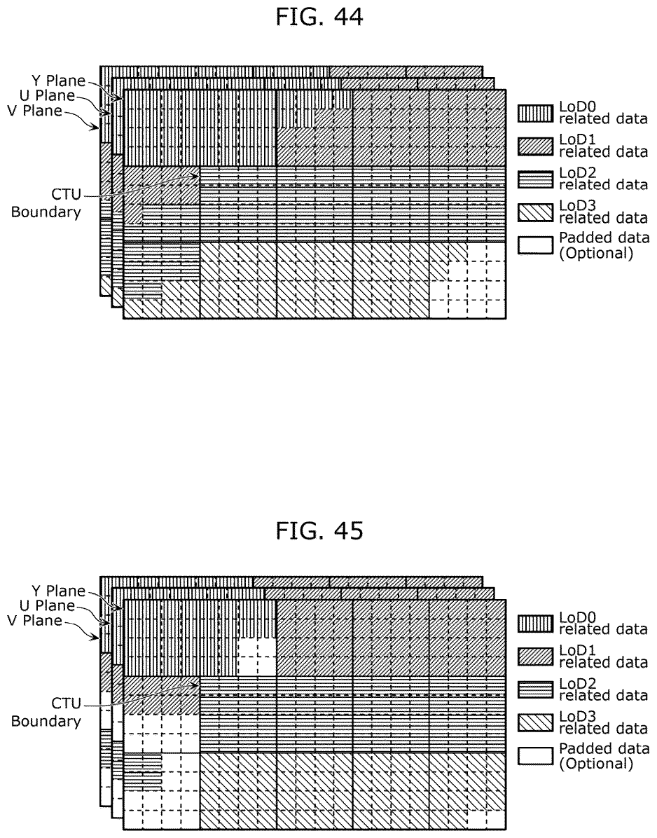

Hereinafter, the packing of displacement information into an image frame will be described with reference to FIG. 43, FIG. 44, and FIG. 45.

FIG. 43, FIG. 44, and FIG. 45 are explanatory diagrams illustrating examples of packing the displacement information into an image frame. Note that the image frame can be rephrased as a video frame.

Items of displacement data on vertices are mapped into, for example, components of an image frame in a YUV format (i.e., into Y components (Y Plane), U components (U Plane), and V components (V Plane)), thus being encoded as image frame data. This case will be described below as an example. Note that, as another example, the items of displacement data on vertices may be mapped into components of an image frame in an RGB format (R components, G components, and B components), thus being encoded as the image frame data.

Decoding device 200 can use an image encoding module to extract the items of displacement data. Each of the items of displacement data may be in the form of an X component, a Y component, or a Z component in a global coordinate system (e.g., a Cartesian coordinate system) or a normal, a tangent, or a bi-tangent component in a local coordinate system. Methods of mapping the displacement data into the image frame include the following methods.

For example, in a first method, the items of displacement data are arranged in a traversing order in the image frame. An example of the packing of the items of displacement data in this case is illustrated in FIG. 43. The items of displacement data are directly mapped onto the image frame according to a predefined traversing order.

Note that the image frame has a fixed height and width, and thus there are cases where the items of displacement data do not fit exactly in the frame. In such a case, the remaining part of the image frame is padded with data for padding (also referred to as Padded data) (see FIG. 43).

For example, in a second method, the items of displacement data are separated into a plurality of LoDs and mapped into the Y components, U components, and V components of the image frame. An example of the packing of the items of displacement data in this case is illustrated in FIG. 44. Here, the items of displacement data in the image frame for the next LoD start immediately after the items of displacement data for the previous LoD end. As in the first method, in the case where the items of displacement data do not exactly fit in the image frame, the image frame is padded at its end portion (see FIG. 44).

For example, in a third method, the items of displacement data corresponding to the LoDs are mapped onto the Y components, U components, and V components of the image frame in a manner different from the second method. An example of the packing of the items of displacement data in this case is illustrated in FIG. 45. In this manner, each LoD can be independently decoded. In the third method, interim padding is performed for each LoD's displacement data to provide CTU alignment together with the padding at the end of the video frame (see FIG. 45).

### Texture

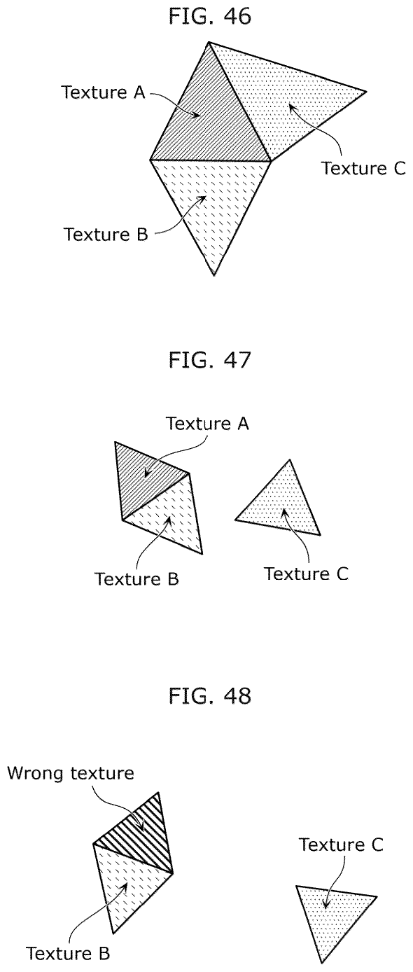

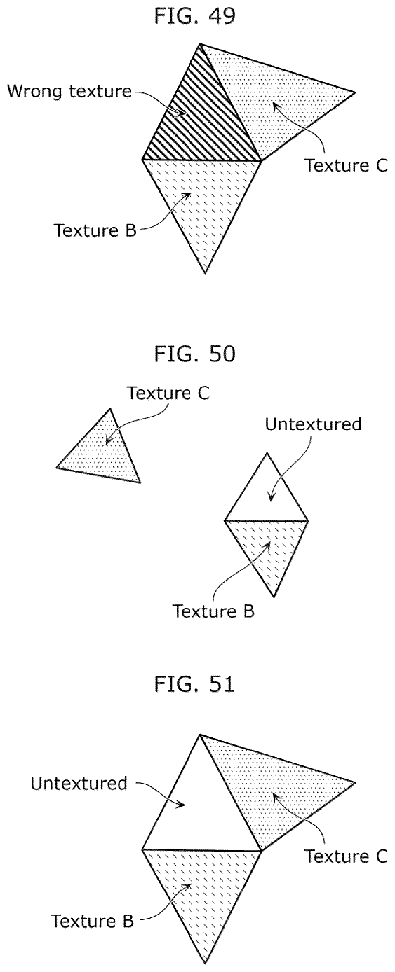

FIG. 46 to FIG. 51 are explanatory diagrams illustrating textures according to the embodiment. Specifically, FIG. 46 is a diagram schematically illustrating textures of a three-dimensional mesh frame inputted to encoding device 100. More specifically, FIG. 46 illustrates an example of a three-dimensional mesh frame containing vertices, their connectivity, and texture coordinates and its associated texture image. FIG. 47 is a diagram schematically illustrating a texture image in the case where the texture of the three-dimensional mesh frame illustrated in FIG. 46 is overlaid on a UV map. FIG. 48 is a diagram schematically illustrating a decoded texture image overlaid on a UV map decoded from the bitstream into which the three-dimensional mesh frame illustrated in FIG. 46 and FIG. 47 has been encoded. FIG. 49 is a diagram schematically illustrating a three-dimensional mesh frame reconstructed using the texture image illustrated in FIG. 48. FIG. 50 is a diagram schematically illustrating another example of a decoded texture image overlaid on a UV map decoded from the bitstream into which the three-dimensional mesh frame illustrated in FIG. 46 and FIG. 47 has been encoded. FIG. 51 is a diagram schematically illustrating a three-dimensional mesh frame reconstructed using the texture image illustrated in FIG. 50.

As illustrated in FIG. 46, it is assumed, for example, that texture A, texture B, and texture C are assigned to three triangles forming the three-dimensional mesh frame. Such a three-dimensional mesh frame is, for example, encoded into a bitstream and transmitted to decoding device 200 by encoding device 100.

In this case, if decoding device 200 decodes the bitstream and reconstructs the three-dimensional mesh frame, texture A may not be appropriately assigned and a wrong texture may be assigned instead, as illustrated in FIG. 48 and FIG. 49.

Alternatively, in this case, if decoding device 200 decodes the bitstream and reconstructs the three-dimensional mesh frame, the reconstructed three-dimensional mesh frame may contain a triangle (face) to which texture A is not appropriately assigned and whose texture is thus missing as illustrated in FIG. 50 and FIG. 51.

To solve the artifacts (data error) due to the wrong application of texture to the surface of the reconstructed three-dimensional mesh frame, a UV map for a three-dimensional mesh frame denser than the base mesh frame is generated. An example of the denser three-dimensional mesh frame can be a base mesh frame subdivided after a certain number of subdivision iterations indicated by a first parameter. In practice, higher LoDs do not significantly improve the quality of the reconstructed three-dimensional mesh frame. Consequently, the first parameter can be smaller than the total number of subdivision iterations to be applied to the base mesh frame. This is to provide balance between computation time/resources to generate a UV map and quality. In order to further improve the quality of the reconstructed three-dimensional mesh frame, the vertices of the subdivided three-dimensional mesh frame may be displaced before texture parametrization depending on a second parameter. Hence, the texture parametrization is performed for a three-dimensional mesh frame whose representation is closer to that of the original three-dimensional mesh frame which may eventually improve the quality of the reconstructed three-dimensional mesh frame.

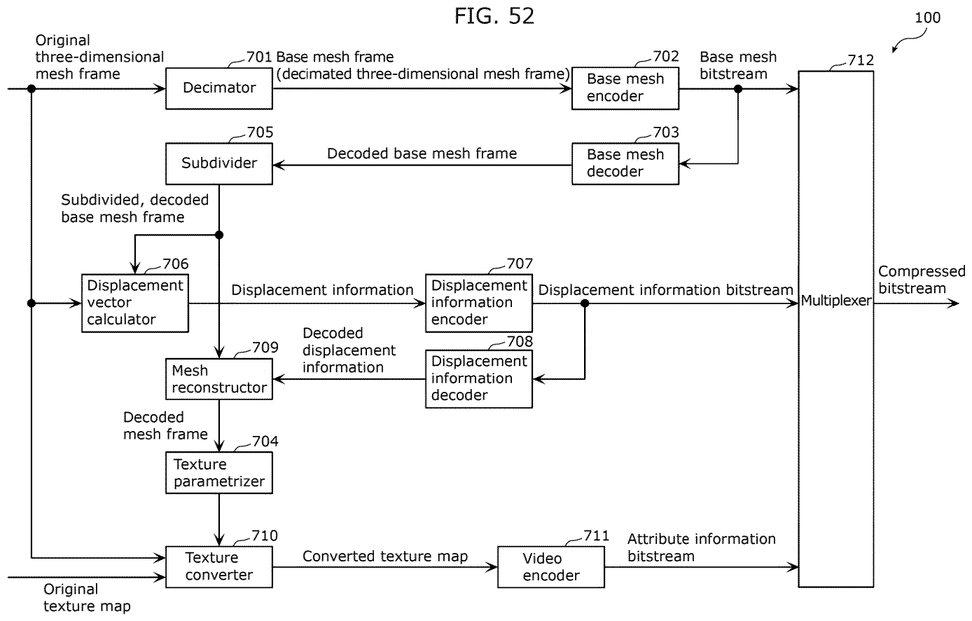

FIG. 52 is a block diagram illustrating yet another configuration example of encoding device 100 according to the embodiment. Specifically, FIG. 52 is a variation of encoding device 100 illustrated in FIG. 35. In the present example, as with encoding device 100 illustrated in FIG. 35, encoding device 100 includes decimator 701, base mesh encoder 702, base mesh decoder 703, texture parametrizer 704, subdivider 705, displacement vector calculator 706, displacement information encoder 707, displacement information decoder 708, mesh reconstructor 709, texture converter 710, video encoder 711, and multiplexer 712. On the other hand, unlike the example illustrated in FIG. 35, texture parametrizer 704 in the present example calculates the texture coordinates, based on the decoded (restored) mesh frame outputted from mesh reconstructor 709.

In the example illustrated in FIG. 35, texture parametrizer 704 calculates the texture coordinates, based on the base mesh frame that is not subdivided and whose vertices are not displaced based on the displacement information. In contrast, in the present example, texture parametrizer 704 calculates the texture coordinates, based on the base mesh frame (mesh frame) that is subdivided and whose vertices are displaced based on the displacement information.

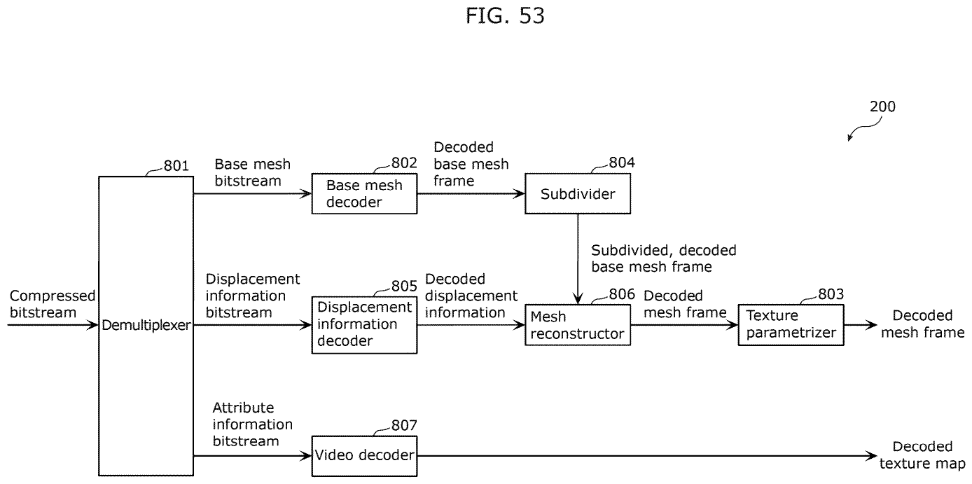

FIG. 53 is a block diagram illustrating yet another configuration example of decoding device 200 according to the embodiment. Specifically, FIG. 53 is a variation of decoding device 200 illustrated in FIG. 36. In this example, as with decoding device 200 illustrated in FIG. 36, decoding device 200 includes demultiplexer 801, base mesh decoder 802, texture parametrizer 803, subdivider 804, displacement information decoder 805, mesh reconstructor 806, and video decoder 807. On the other hand, unlike the example illustrated in FIG. 36, texture parametrizer 803 in the present example calculates the texture coordinates, based on the decoded mesh frame outputted from mesh reconstructor 806.

In the example illustrated in FIG. 36, texture parametrizer 803 calculates the texture coordinates, based on the base mesh frame that is not subdivided and whose vertices are not displaced based on the displacement information. In contrast, in the present example, texture parametrizer 803 calculates the texture coordinates, based on the decoded base mesh frame (mesh frame) that is subdivided and whose vertices are displaced based on the displacement information.

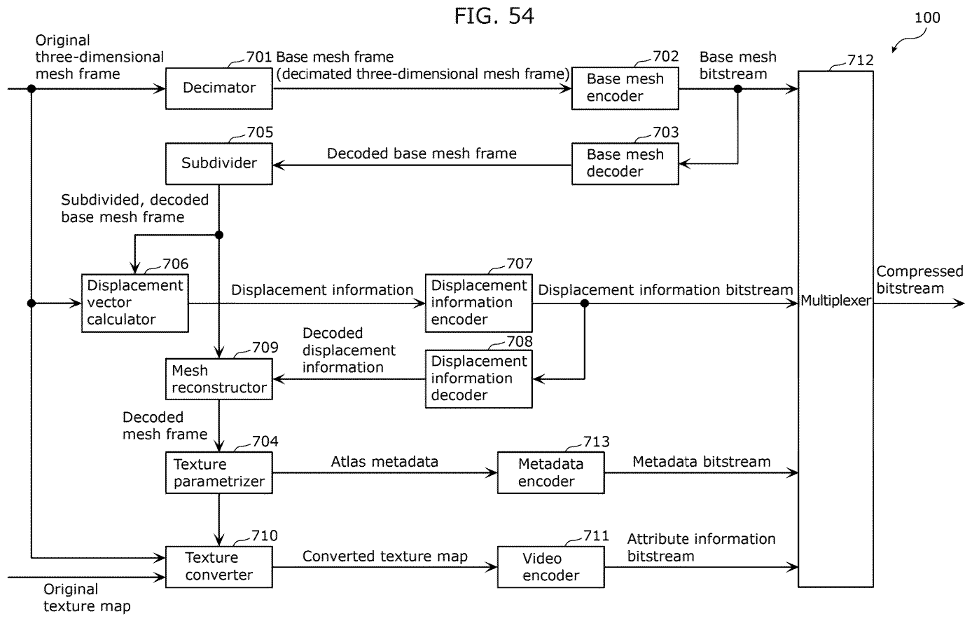

FIG. 54 is a block diagram illustrating yet another configuration example of encoding device 100 according to the embodiment. Specifically, FIG. 54 is a variation of encoding device 100 illustrated in FIG. 52. In the present example, encoding device 100 includes metadata encoder 713 in addition to the configuration of encoding device 100 illustrated in FIG. 52.

In the present example, texture parametrizer 704 calculates the texture coordinates, based on the decoded mesh frame, and outputs, to metadata encoder 713, atlas metadata that is auxiliary information for calculating the texture coordinates, based on the decoded mesh frame.

Metadata encoder 713 generates a metadata bitstream including the atlas metadata, and outputs the generated metadata bitstream to multiplexer 712.

In the present example, multiplexer 712 generates and outputs a compressed bitstream including: the metadata bitstream; the base mesh bitstream; the displacement information bitstream; and the attribute information bitstream.

As described above, encoding device 100 in the example illustrated in FIG. 52 does not transmit the atlas metadata, whereas encoding device 100 in the present example transmits the atlas metadata.

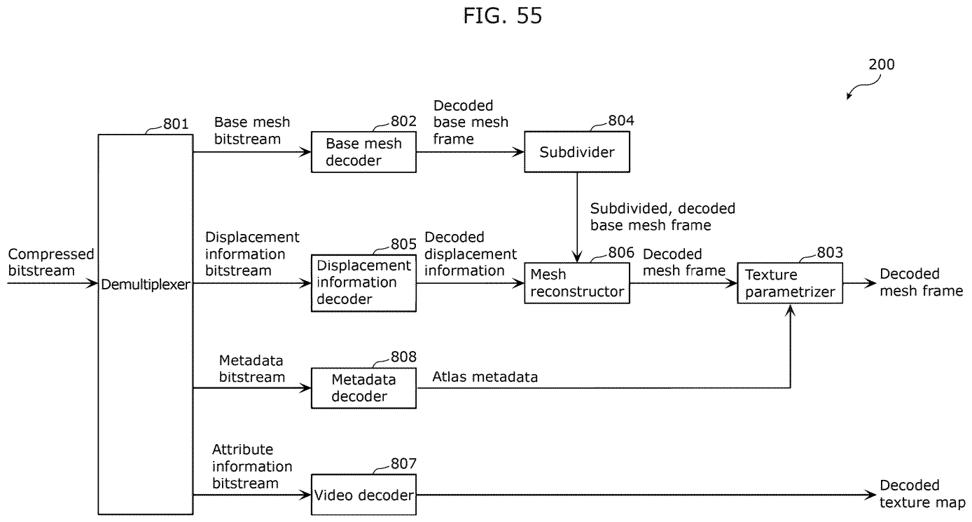

FIG. 55 is a block diagram illustrating yet another configuration example of decoding device 200 according to the embodiment. Specifically, FIG. 55 is a variation of decoding device 200 illustrated in FIG. 53. In the present example, decoding device 200 includes metadata decoder 808 in addition to the configuration of decoding device 200 illustrated in FIG. 53.

In the present example, demultiplexer 801 separates the compressed bitstream into a metadata bitstream, a base mesh bitstream, a displacement information bitstream, and an attribute information bitstream. Demultiplexer 801 outputs the metadata bitstream to metadata decoder 808, outputs the base mesh bitstream to base mesh decoder 802, outputs the displacement information bitstream to displacement information decoder 805, and outputs the attribute information bitstream to video decoder 807.

Metadata decoder 808 decodes the atlas metadata from the metadata bitstream, and outputs the decoded atlas metadata to texture parametrizer 803.

Note that the present example has illustrated the case where the texture coordinates are calculated using the atlas metadata; however, if the texture coordinates are directly encoded into the metadata bitstream, texture parametrizer 803 need not calculate the texture coordinates. For example, texture parametrizer 803 may output the decoded texture coordinates and the decoded base mesh frame to subdivider 804. In this case, decoding device 200 need not include texture parametrizer 803.

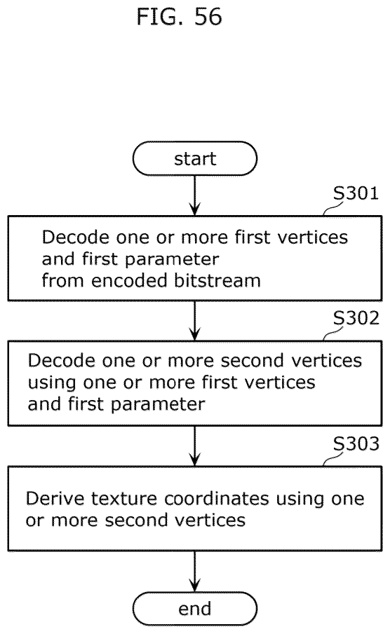

FIG. 56 is a flowchart illustrating an example of a texture coordinate derivation process according to the embodiment. For example, decoding device 200 performs the processes illustrated in the flowchart in FIG. 56.

First, decoding device 200 decodes one or more first vertices and a first parameter from an encoded bitstream (S301). The one or more first vertices are part of a three-dimensional mesh frame. For example, the one or more first vertices are vertices of a base mesh frame. For example, the three-dimensional mesh frame is a submesh frame. For example, the first parameter is signaled in a frame header. For example, the first parameter is signaled in a sequence header. For example, the first parameter indicates the total number of subdivision iterations to be applied to the one or more first vertices.

Next, decoding device 200 decodes one or more second vertices using the one or more first vertices and the first parameter (S302). The position of each second vertex is derived using one or more positions of the one or more first vertices and the first parameter. The one or more first vertices and the one or more second vertices are part of the same three-dimensional mesh frame. For example, the one or more second vertices are vertices of a subdivided mesh frame. For example, decoding device 200 may decode a second parameter. For example, the second parameter indicates whether the one or more second vertices are to be displaced before the texture coordinates are derived. For example, the second parameter is signaled in a frame header. For example, the second parameter is signaled in a sequence header.

Next, decoding device 200 derives texture coordinates using one or more positions of the one or more second vertices (S303). For example, decoding device 200 decodes (calculates) the texture coordinates using a refined mesh frame (for example, a mesh frame that is subdivided and whose vertices are displaced based on the displacement information).

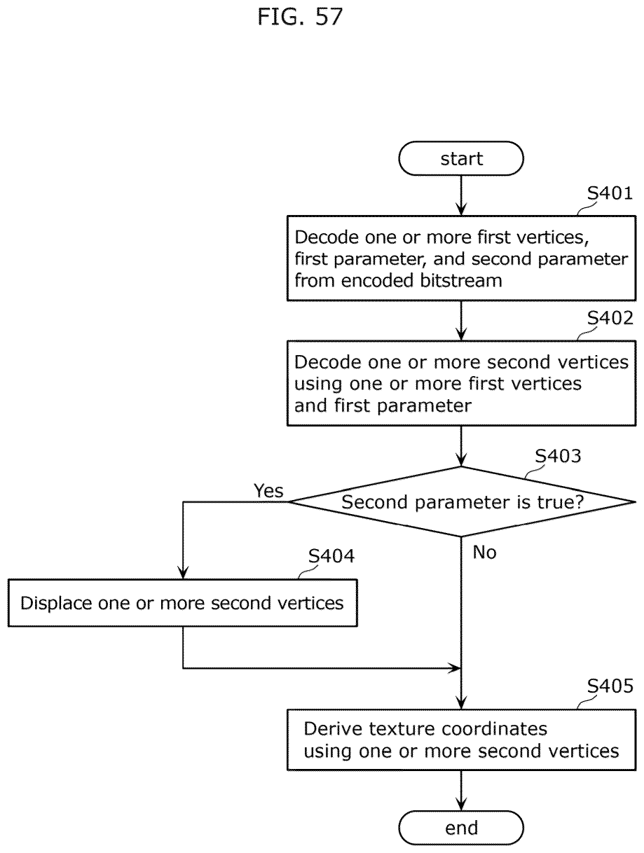

FIG. 57 is a flowchart illustrating another example of a texture coordinate derivation process according to the embodiment.

First, decoding device 200 decodes one or more first vertices, a first parameter, and a second parameter from an encoded bitstream (S401). For example, the one or more first vertices are part of a three-dimensional mesh frame. For example, the second parameter is of boolean data type.

Next, decoding device 200 decodes one or more second vertices using one or more first vertices and the first parameter (S402). For example, the position of each second vertex is derived using one or more positions of the one or more first vertices and the first parameter. For example, the one or more first vertices and the one or more second vertices are part of the same three-dimensional mesh frame.

Next, decoding device 200 determines the value of the second parameter (S403).

If the second parameter is true (Yes in S403), decoding device 200 displaces the one or more second vertices (S404).

If the second parameter is not true (No in S403) or after step S404, decoding device 200 derives the texture coordinates using one or more positions of the one or more second vertices (S405). For example, in the case of Yes in step S403, decoding device 200 calculates texture coordinates using the mesh frame whose one or more second vertices have been displaced, whereas in the case of No in step S403, decoding device 200 calculates texture coordinates using the mesh frame whose one or more second vertices are not displaced.

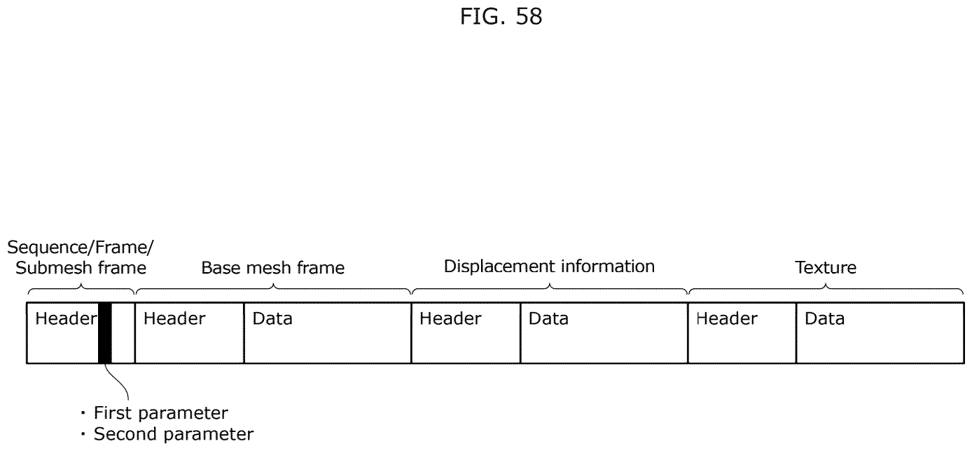

FIG. 58 is a diagram illustrating an example of a layout of syntax parameters according to the embodiment.

For example, the first parameter and the second parameter are signaled in a sequence header, a frame header, or a submesh frame header. The sequence header may be referred to by one or more frames. The frame header may be referred to by one or more submesh frames.

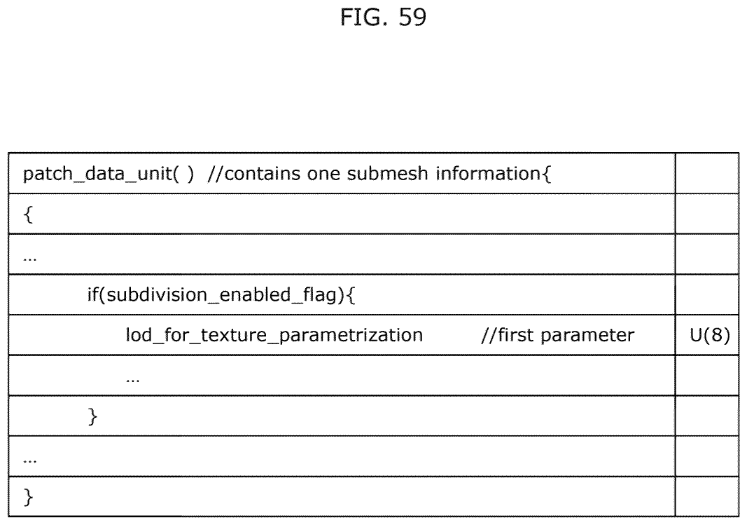

FIG. 59 illustrates an example of a syntax for signaling the first parameter according to the embodiment. Specifically, FIG. 59 illustrates an example of a syntax for signaling the first parameter that indicates a total number of subdivision iterations before texture parametrization. Note that the first parameter may be signaled as a differential value from the total number of subdivision iterations for reconstruction of the submesh frame.

subdivision_enabled_flag is a flag indicating whether to perform subdivision.

For example, subdivision_enabled_flag equal to 1 indicates that lod_for_texture_parametrization may be present in a patch. On the other hand, subdivision_enabled_flag equal to 0 indicates that lod_for_texture_parametrization is not present in a patch.

lod_for_texture_parametrization indicates the total number of subdivision iterations used for the subdivision before texture parametrization in a patch. When lod_for_texture_parametrization is not present, its value is inferred to be equal to 0. lod_for_texture_parametrization is an example of the first count information and the second count information.

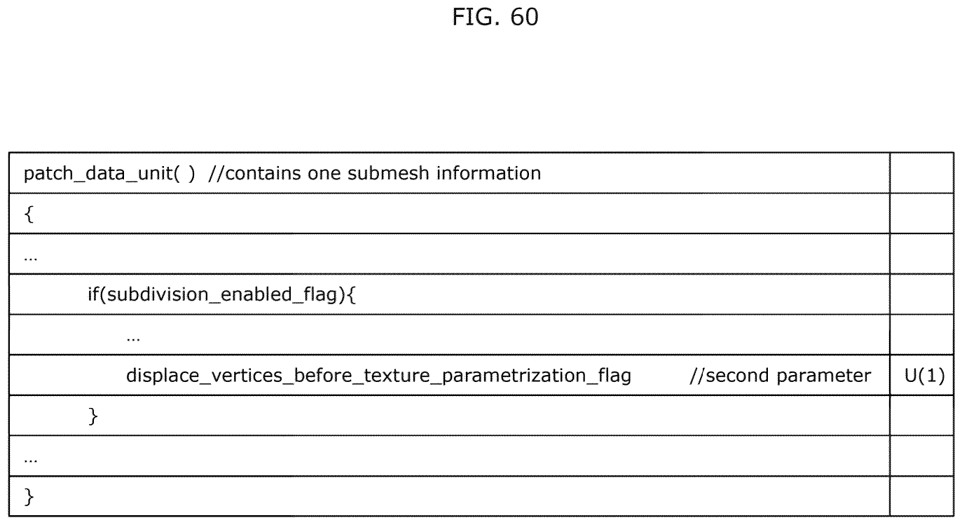

FIG. 60 illustrates an example of a syntax for signaling the second parameter according to the embodiment. Specifically, FIG. 60 illustrates an example of a syntax for signaling the second parameter that indicates whether to displace vertices before texture parametrization.

displace_vertices_before_texture_parametrization_flag is information indicating whether to displace vertices. displace_vertices_before_texture_parametrization_flag is an example of the flag information.

For example, displace_vertices_before_texture_parametrization_flag equal to 1 indicates that the vertices after being subjected to subdivision iterations the total number of which is indicated by lod_for_texture_parametrization are displaced before texture parametrization is applied in a patch.

When displace_vertices_before_texture_parametrization_flag is not present, its value is inferred to be equal to 0.

If the texture coordinates are signaled in the bitstream, decoding device 200 first decodes the base mesh frame and subdivides the base mesh frame at the total number of subdivision iterations indicated by the first parameter to derive the refined mesh frame. The texture coordinates corresponding to the refined mesh frame may be decoded by a base mesh codec or may be decoded by any decoding device other than decoding device 200 (for example, other than decoding device 200 according to the present disclosure), or the texture coordinates decoded by the base mesh codec may be subdivided.

Next, decoding device 200 checks whether the second parameter exists in the bitstream, and displaces vertices of the refined mesh frame. Decoding device 200 applies displacement to the refined mesh frame depending on the decoded flag.

Lastly, the vertices of the refined mesh frame are paired up with the decoded texture coordinates. The pairing of the vertices and the texture coordinates need not be strict one-to-one mapping. That is to say, one vertex may have two or more sets of texture coordinates, and two or more vertices may have one set of texture coordinates (stated differently, the same texture coordinates).

With such a configuration as described above, the present disclosure can improve the quality of the three-dimensional mesh frame reconstructed. Note that the present disclosure is not limited to the tools (for example, orthoAtlas or UVAtlas) used for generating texture coordinates (UV coordinates). Also, the present disclosure can work in both the case of the UV map (texture image) being signaled in the bitstream and the case of high-level syntax parameters used by decoding device 200 for generating the UV map.

Decoding device 200 can be implemented by combining at least part of other aspects of the present disclosure. In addition, the present disclosure may be implemented by combining, with other aspects, part of the processes indicated in any of the flowcharts according to one aspect, part of the configuration of any of the devices, part of syntaxes, etc.

The above process of decoding device 200 may be performed similarly in encoding device 100 as well. In addition, not all the constituent elements in the present disclosure are always necessary, and only part of the constituent elements of the present disclosure may be included.

### Conclusion

As described above, for example, encoding device 100 includes: circuit 151; and memory 152 connected to circuit 151, in which, in operation, circuit 151: encodes one or more first vertices and a first parameter from an encoded bitstream, the one or more first vertices being part of a three-dimensional mesh frame; encodes one or more second vertices using the one or more first vertices and the first parameter, a position of each of the one or more second vertices being derived using one or more positions of the one or more first vertices and the first parameter, the one or more first vertices and the one or more second vertices being part of the same three-dimensional mesh frame; and derives a texture coordinate using the one or more second vertices, the texture coordinate being derived using one or more positions of the one or more second vertices.

In addition, for example, decoding device 200 includes: circuit 251; and memory 252 connected to circuit 251, in which, in operation, circuit 251: decodes one or more first vertices and a first parameter from an encoded bitstream, the one or more first vertices being part of a three-dimensional mesh frame; decodes one or more second vertices using the one or more first vertices and the first parameter, a position of each of the one or more second vertices being derived using one or more positions of the one or more first vertices and the first parameter, the one or more first vertices and the one or more second vertices being part of the same three-dimensional mesh frame; and derives a texture coordinate using the one or more second vertices, the texture coordinate being derived using one or more positions of the one or more second vertices.

In addition, for example, an encoding method includes: encoding one or more first vertices and a first parameter from an encoded bitstream, the one or more first vertices being part of a 3D mesh; encoding one or more second vertices using the one or more first vertices and the first parameter, a position of each of the one or more second vertices being derived using one or more positions of the one or more first vertices and the first parameter, the one or more first vertices and the one or more second vertices being part of the same three-dimensional mesh frame; and deriving a texture coordinate using the one or more second vertices, the texture coordinate being derived using one or more positions of the one or more second vertices.

In addition, for example, a decoding method includes: decoding one or more first vertices and a first parameter from an encoded bitstream, the one or more first vertices being part of a three-dimensional mesh frame; decoding one or more second vertices using the one or more first vertices and the first parameter, a position of each of the one or more second vertices being derived using one or more positions of the one or more first vertices and the first parameter, the one or more first vertices and the one or more second vertices being part of the same three-dimensional mesh frame; and deriving a texture coordinate using the one or more second vertices, the texture coordinate being derived using one or more positions of the one or more second vertices.

In addition, for example, the three-dimensional mesh frame is a submesh.

In addition, for example, in the decoding, a second parameter is decoded, and the second parameter indicates whether to displace the one or more second vertices before the derivation of the texture coordinates.

In addition, for example, each of the one or more first vertices is a base mesh (specifically, a vertex included in a base mesh).

In addition, for example, each of the one or more second vertices is a subdivided mesh (specifically, a vertex included in a submesh).

In addition, for example, the first parameter is signaled in a frame header.

In addition, for example, the second parameter is signaled in a frame header.

In addition, for example, the first parameter is signaled in a sequence header.

In addition, for example, the second parameter is signaled in a sequence header.

In addition, for example, the first parameter indicates the total number of subdivision iterations to be applied to the one or more first vertices.

In the encoding technique for multimedia data, there is a demand for new methods for improving the encoding efficiency and the image quality and for reducing the circuit size.

Each of one or more embodiments, some of the constituent elements, and each of the methods according to the present disclosure enables, for example, at least one of improvement in encoding efficiency, improvement in image quality, reduction in encoding/decoding processing amount, reduction in circuit size, improvement in encoding/decoding processing speed, or the like. Alternatively, each embodiment according to the present disclosure partially or entirely enables any of an element such as a filter, a block, a size, a motion vector, a reference picture, and a reference block, or an arithmetic operation to be appropriately selected in encoding and decoding. The present disclosure may include a disclosure relating to a configuration and a method that can provide an advantage other than the advantages described above. Examples of such a configuration and a method include a configuration or a method that improves the encoding efficiency while suppressing an increase in the processing amount.

Additional values and advantages of aspects of the present disclosure will be apparent from the specification and the drawings. The values and/or advantages can be provided by each of the various embodiments and features described in the specification and the drawings, and not all the embodiments and features in the specification and the drawings are necessary to provide one or more of such values and/or advantages.

These general or specific aspects can be implemented by using a system, an integrated circuit, a computer program, a computer-readable recording medium such as a CD-ROM, or any combination of systems, methods, integrated circuits, computer programs, or computer-readable recording media.

### Representative Examples

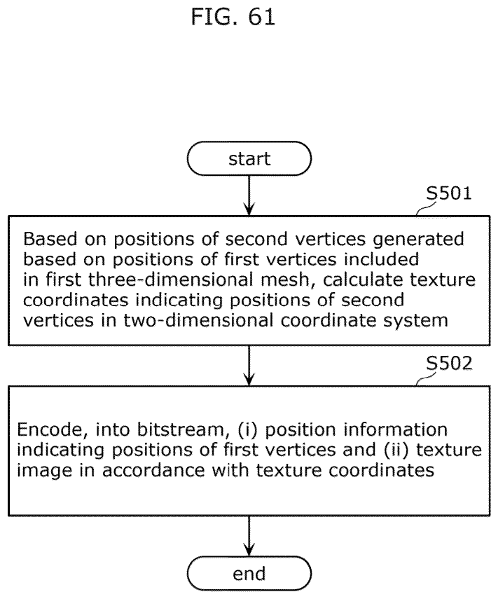

FIG. 61 is a flowchart illustrating an example of a basic encoding process according to the present embodiment. For example, encoding device 100 illustrated in FIG. 24 includes circuit 151 and memory 152 connected to circuit 151, and circuit 151, in operation, performs the encoding process illustrated in FIG. 61.

First, based on positions of a plurality of second vertices generated based on positions of a plurality of first vertices included in a first three-dimensional mesh frame, encoding device 100 calculates texture coordinates indicating positions of the plurality of second vertices in a two-dimensional coordinate system (S501).

Next, encoding device 100 encodes, into a bitstream, (i) position information indicating the positions of the plurality of first vertices and (ii) a texture image that is in accordance with the texture coordinates (S502). That is to say, encoding device 100 generates a bitstream including the position information and the texture image.

The first three-dimensional mesh frame is the above-described base mesh frame, for example. The plurality of first vertices are, for example, a plurality of three-dimensional points included in the base mesh frame. The second vertices are, for example, three-dimensional points generated as a result of subdivision of the base mesh frame. The two-dimensional coordinates are, for example, coordinates in the texture image. The texture image is, for example, the attribute image (texture data) described above.

The plurality of second vertices are generated as a result of subdivision of the first three-dimensional mesh frame, for example. This makes it possible to generate a mesh frame denser than the first three-dimensional mesh frame. By calculating texture coordinates based on the mesh frame generated in such a manner, that is, by determining the texture of the mesh frame, it is possible to determine the texture coordinates more finely than in the case of calculating the texture coordinates based on the plurality of first vertices. Accordingly, defects such as application of a wrong texture or no texture to the first three-dimensional mesh frame by a decoding process or the like can be inhibited.

In addition, for example, encoding device 100 generates the texture image based on the texture coordinates.

With this, only the texture image related to the calculated texture coordinates is encoded into the bitstream. Accordingly, the code amount of the bitstream is reduced.

In addition, for example, encoding device 100 further generates the plurality of second vertices by subdividing the first three-dimensional mesh frame.

This makes it possible to determine the texture coordinates more finely than in the case of calculating the texture coordinates based on the plurality of first vertices.

In addition, for example, encoding device 100 further encodes, into the bitstream, first count information indicating a total number of times the first three-dimensional mesh frame is subdivided to calculate the texture coordinates.

The first count information is the above-described first parameter, for example.

This makes it possible to perform subdivisions the same number of times in encoding and decoding. Accordingly, the quality of the three-dimensional mesh frame reconstructed by decoding device 200 can be improved.

In addition, for example, encoding device 100 further encodes, into the bitstream, second count information indicating a total number of times the first three-dimensional mesh frame is subdivided to generate a second three-dimensional mesh frame from the first three-dimensional mesh frame.

The second three-dimensional mesh frame is the above-described original mesh frame, for example. The second count information is the above-described first parameter, for example.

Note that in the above example, the total number of times the first three-dimensional mesh frame is subdivided to calculate texture coordinates and the total number of times the first three-dimensional mesh frame is subdivided to generate the second three-dimensional mesh frame from the first three-dimensional mesh frame are the same; therefore, the first parameter indicates both the first count information and the second count information. If these numbers are different, parameters indicating these numbers may be included in the bitstream.

With this, for example, even when a difference exists between the total number of times the first three-dimensional mesh frame is subdivided to calculate texture coordinates and the total number of times the first three-dimensional mesh frame is subdivided to generate the second three-dimensional mesh frame from the first three-dimensional mesh frame, encoding device 100 and decoding device 200 can perform subdivisions the same number of times. Accordingly, the quality of the three-dimensional mesh frame reconstructed by decoding device 200 can be improved.

In addition, for example, encoding device 100 further: displaces the plurality of second vertices; and when calculating the texture coordinates, calculates the texture coordinates based on the positions of the plurality of second vertices after displacement.

For example, encoding device 100 encodes, into a bitstream, the above-described displacement information as information indicating the amount of displacement of the vertices.

With this, even when vertices are displaced and then position information indicating the positions of the displaced vertices is encoded, encoding device 100 and decoding device 200 can calculate texture coordinates using vertices of the same positions.

In addition, for example, encoding device 100 encodes, into the bitstream, flag information indicating whether to displace the plurality of second vertices.

The flag information is the above-described second parameter, for example.

This makes it possible for decoding device 200 to determine whether to displace vertices based on the flag information.

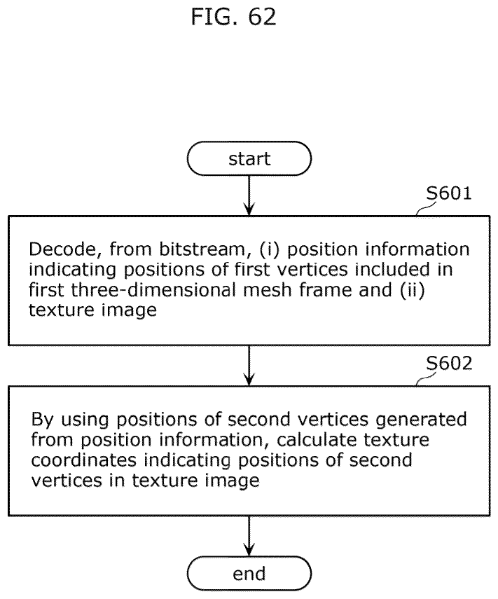

FIG. 62 is a flowchart illustrating an example of a basic decoding process according to the present embodiment. For example, decoding device 200 illustrated in FIG. 25 includes circuit 251 and memory 252 connected to circuit 251, and circuit 251, in operation, performs the decoding process illustrated in FIG. 62.

First, decoding device 200 decodes, from a bitstream, (i) position information indicating positions of a plurality of first vertices included in a first three-dimensional mesh frame and (ii) a texture image (S601). That is to say, decoding device 200 obtains the position information and the texture image from the bitstream.

Next, by using positions of a plurality of second vertices generated from the position information, decoding device 200 calculates texture coordinates indicating positions of the plurality of second vertices in the texture image (S602). Decoding device 200 reconstructs a three-dimensional mesh frame by using the position information, the texture image, and the texture coordinates.

The plurality of second vertices are generated as a result of subdivision of the first three-dimensional mesh frame, for example. This makes it possible to generate a mesh frame denser than the first three-dimensional mesh frame. By calculating texture coordinates based on the mesh frame generated in such a manner, that is, by determining the texture of the mesh frame, it is possible to determine the texture coordinates more finely than in the case of calculating the texture coordinates based on the plurality of first vertices. Accordingly, defects such as application of a wrong texture or no texture to the first three-dimensional mesh frame by a decoding process or the like can be inhibited.

In addition, for example, decoding device 200 further generates the plurality of second vertices by subdividing the first three-dimensional mesh frame.

This makes it possible to determine the texture coordinates more finely than in the case of calculating the texture coordinates based on the plurality of first vertices.

In addition, for example, decoding device 200 further: decodes, from the bitstream, first count information indicating a total number of times the first three-dimensional mesh frame is subdivided to calculate the texture coordinates; and when calculating the texture coordinates, calculates the texture coordinates using the first count information.

This makes it possible to perform subdivisions the same number of times in encoding and decoding. Accordingly, the quality of the three-dimensional mesh frame reconstructed by decoding device 200 can be improved.

In addition, for example, decoding device 200 further: decodes, from the bitstream, second count information indicating a total number of times the first three-dimensional mesh frame is subdivided to generate a second three-dimensional mesh frame from the first three-dimensional mesh frame; and generates the second three-dimensional mesh frame from the first three-dimensional mesh frame by using the texture coordinates and the second count information.

With this, for example, even when a difference exists between the total number of times the first three-dimensional mesh frame is subdivided to calculate texture coordinates and the total number of times the first three-dimensional mesh frame is subdivided to generate the second three-dimensional mesh frame from the first three-dimensional mesh frame, encoding device 100 and decoding device 200 can perform subdivisions the same number of times. Accordingly, the quality of the three-dimensional mesh frame reconstructed by decoding device 200 can be improved.

In addition, for example, decoding device 200 further: displaces the plurality of second vertices; and when calculating the texture coordinates, calculates the texture coordinates based on the positions of the plurality of second vertices after displacement.

With this, even when vertices are displaced and then position information indicating the positions of the displaced vertices is encoded, encoding device 100 and decoding device 200 can calculate texture coordinates using vertices of the same positions.

In addition, for example, decoding device 200 decodes, from the bitstream, flag information indicating whether to displace the plurality of second vertices.

This makes it possible for decoding device 200 to determine whether to displace vertices based on the flag information.

### Other Examples

Although aspects of encoding device 100 and decoding device 200 have thus far been described according to the embodiment, the aspects of encoding device 100 and decoding device 200 are not limited to the embodiment. Modifications that may be conceived by a person skilled in the art may be applied to the embodiment, and a plurality of constituent elements in the embodiment may be combined in any manner.

For example, processing performed by a specific constituent element in the embodiment may be performed by a different constituent element instead of the specific constituent element. Moreover, the order of processes may be changed or processes may be performed in parallel.

Moreover, as stated above, it is possible to implement, as an integrated circuit, at least part of the plurality of constituent elements in the present disclosure. At least some of the processes in the present disclosure may be used as an encoding method or a decoding method. A program for causing a computer to execute the encoding method or the decoding method may be used. Furthermore, a non-transitory computer-readable recording medium on which the program is recorded may be used. In addition, a bitstream for causing decoding device 200 to perform a decoding process may be used.

Moreover, at least some of the plurality of constituent elements and the processes in the present disclosure may be used as a transmitting device, a receiving device, a transmitting method, and a receiving method. A program for causing a computer to execute the transmitting method or the receiving method may be used. Furthermore, a non-transitory computer-readable recording medium on which the program is recorded may be used.

### INDUSTRIAL APPLICABILITY

The present disclosure is useful in, for example, an encoding device, a decoding device, a transmitting device, a receiving device, and the like related to a three-dimensional mesh and can be applied to a computer graphics system, a three-dimensional data display system, and the like.

1. An encoding device comprising:
a circuit; and
memory connected to the circuit, wherein in operation, the circuit:
based on positions of a plurality of second vertices generated based on positions of a plurality of first vertices included in a first three-dimensional mesh frame, calculates texture coordinates indicating positions of the plurality of second vertices in a two-dimensional coordinate system; and
encodes, into a bitstream, (i) position information indicating the positions of the plurality of first vertices and (ii) a texture image that is in accordance with the texture coordinates.

2. The encoding device according to claim 1, wherein
the circuit further generates the texture image based on the texture coordinates.

3. The encoding device according to claim 1, wherein
the circuit further generates the plurality of second vertices by subdividing the first three-dimensional mesh frame.

4. The encoding device according to claim 1, wherein
the circuit further encodes, into the bitstream, first count information indicating a total number of times the first three-dimensional mesh frame is subdivided to calculate the texture coordinates.

5. The encoding device according to claim 1, wherein
the circuit further encodes, into the bitstream, second count information indicating a total number of times the first three-dimensional mesh frame is subdivided to generate a second three-dimensional mesh frame from the first three-dimensional mesh frame.

6. The encoding device according to claim 1, wherein
the circuit further:
displaces the plurality of second vertices; and
when calculating the texture coordinates, calculates the texture coordinates based on the positions of the plurality of second vertices after displacement.

7. The encoding device according to claim 1, wherein
the circuit encodes, into the bitstream, flag information indicating whether to displace the plurality of second vertices.

8. A decoding device comprising:
a circuit; and
memory connected to the circuit, wherein
in operation, the circuit:
decodes, from a bitstream, (i) position information indicating positions of a plurality of first vertices included in a first three-dimensional mesh frame and (ii) a texture image; and
by using positions of a plurality of second vertices generated from the position information, calculates texture coordinates indicating positions of the plurality of second vertices in the texture image.

9. The decoding device according to claim 8, wherein
the circuit further generates the plurality of second vertices by subdividing the first three-dimensional mesh frame.

10. The decoding device according to claim 8, wherein
the circuit further:
decodes, from the bitstream, first count information indicating a total number of times the first three-dimensional mesh frame is subdivided to calculate the texture coordinates; and
when calculating the texture coordinates, calculates the texture coordinates using the first count information.

11. The decoding device according to claim 8, wherein
the circuit further:
decodes, from the bitstream, second count information indicating a total number of times the first three-dimensional mesh frame is subdivided to generate a second three-dimensional mesh frame from the first three-dimensional mesh frame; and
generates the second three-dimensional mesh frame from the first three-dimensional mesh frame by using the texture coordinates and the second count information.

12. The decoding device according to claim 8, wherein
the circuit further:
displaces the plurality of second vertices; and
when calculating the texture coordinates, calculates the texture coordinates based on the positions of the plurality of second vertices after displacement.

13. The decoding device according to claim 8, wherein
the circuit decodes, from the bitstream, flag information indicating whether to displace the plurality of second vertices.

14. An encoding method comprising:
based on positions of a plurality of second vertices generated based on positions of a plurality of first vertices included in a first three-dimensional mesh frame, calculating texture coordinates indicating positions of the plurality of second vertices in a two-dimensional coordinate system; and
encoding, into a bitstream, (i) position information indicating the positions of the plurality of first vertices and (ii) a texture image that is in accordance with the texture coordinates.

15. A decoding method comprising:
decoding, from a bitstream, (i) position information indicating positions of a plurality of first vertices included in a first three-dimensional mesh frame and (ii) a texture image; and
by using positions of a plurality of second vertices generated from the position information, calculating texture coordinates indicating positions of the plurality of second vertices in the texture image.
